(19) United States
(12) Patent Application Publication
(10) Pub. No.: US 2026/0181495 A1
(43) Pub. Date: Jun. 25, 2026

(54) CELL SWITCH COMMAND FOR DECOUPLED DOWNLINK AND UPLINK OPERATION

(71) Applicant: QUALCOMM Incorporated, San Diego, CA (US)

(72) Inventors: Kiran VENUGOPAL, Green Brook, NJ (US); Yan ZHOU, San Diego, CA (US)

(21) Appl. No.: 18/990,929

(22) Filed: Dec. 20, 2024

(51) Int. Cl. H04W 36/00; H04W 36/08

(52) U.S. Cl. CPC H04W 36/0072; H04W 36/0058; H04W 36/08

(57) ABSTRACT

Methods, systems, and devices for wireless communication are described. A network may support enabling separate handover, or cell switch, for uplink and downlink communications. In a first scenario, a user equipment (UE) may receive a control message indicating multiple separate configurations for different transmit-receive points (TRPs) or other network entities and related cells, and may receive one or more cell switch commands according to message formats that may define an uplink cell and downlink cell separately. In some examples, separate cell switch commands may indicate different cells for uplink and downlink, or a single cell switch command may include multiple fields to indicate uplink and downlink cells. In a second scenario, the UE may receive a control message defining a virtual cell with a single configuration for multiple TRPs, or other network entities, that may each support downlink, uplink, or both.

### FIELD OF TECHNOLOGY

The following relates to wireless communication, including cell switch command for decoupled downlink and uplink operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein. For example, a network may support enabling separate handover, or cell switch, for uplink and downlink communications. In a first scenario, a user equipment (UE) may receive a control message indicating multiple separate configurations for different transmit-receive points (TRPs) or other network entities and related cells (e.g., serving cells, target candidate cells). The UE may further receive one or more cell switch commands according to message formats (e.g., a medium access control (MAC) control element (MAC-CE) format) that may indicate or define an uplink cell and downlink cell separately (e.g., using separate identifiers). That is, a cell switch command may indicate that a UE is to perform a cell switch for uplink signaling (e.g., from a first uplink-only cell to a second uplink-only cell), or may indicate that the UE is to perform a cell switch for downlink signaling (e.g., from a first downlink-only cell to a second downlink-only cell), or both. Additionally, or alternatively, a switch may involve switching from a cell supporting both downlink and uplink to one cell for downlink and another cell for uplink, or vice versa. In some examples, separate cell switch commands may indicate different cells for uplink and downlink, or a single cell switch command may include multiple fields to indicate uplink and downlink cells. In a second scenario, a UE may receive control signaling defining a virtual cell with a single configuration for multiple TRPs, or other network entities, that may each support downlink, uplink, or both. In a virtual cell, the UE may receive one or more cell switch commands according to a message format that may indicate to switch to an uplink cell (e.g., a first TRP) and a downlink cell (e.g., a second TRP) of the virtual cell using the single configuration. In some examples, one or more transmission configuration indicator (TCI) state pools may be shared across TRPs (e.g., to support backwards compatible MAC-CE message formats), or may be TRP-specific (e.g., to reduce overhead in transmissions due to frequent mobility). Further, a network may support network entities with diverse support for uplink communications, downlink communications, or both.

A method for wireless communication by a user equipment (UE) is described. The method may include receiving one or more control messages indicating a set of multiple configurations for a set of multiple candidate target cells, receiving one or more cell switch commands, the one or more cell switch commands indicating a first candidate target cell of the set of multiple candidate target cells for use in downlink communications, a second candidate target cell of the set of multiple candidate target cells for use in uplink communications, or both, and switching from a first serving cell to the first candidate target cell for downlink communications, from the first serving cell to the second candidate target cell for uplink communications, or both, in response to the received one or more cell switch commands.

A UE for wireless communication is described. The UE may include one or more memories storing processor executable code, and one or more processors coupled with the one or more memories. The one or more processors may individually or collectively be operable to execute the code to cause the UE to receive one or more control messages indicating a set of multiple configurations for a set of multiple candidate target cells, receive one or more cell switch commands, the one or more cell switch commands indicating a first candidate target cell of the set of multiple candidate target cells for use in downlink communications, a second candidate target cell of the set of multiple candidate target cells for use in uplink communications, or both, and switch from a first serving cell to the first candidate target cell for downlink communications, from the first serving cell to the second candidate target cell for uplink communications, or both, in response to the received one or more cell switch commands.

Another UE for wireless communication is described. The UE may include means for receiving one or more control messages indicating a set of multiple configurations for a set of multiple candidate target cells, means for receiving one or more cell switch commands, the one or more cell switch commands indicating a first candidate target cell of the set of multiple candidate target cells for use in downlink communications, a second candidate target cell of the set of multiple candidate target cells for use in uplink communications, or both, and means for switching from a first serving cell to the first candidate target cell for downlink communications, from the first serving cell to the second candidate target cell for uplink communications, or both, in response to the received one or more cell switch commands.

A non-transitory computer-readable medium storing code for wireless communication is described. The code may include instructions executable by one or more processors to receive one or more control messages indicating a set of multiple configurations for a set of multiple candidate target cells, receive one or more cell switch commands, the one or more cell switch commands indicating a first candidate target cell of the set of multiple candidate target cells for use in downlink communications, a second candidate target cell of the set of multiple candidate target cells for use in uplink communications, or both, and switch from a first serving cell to the first candidate target cell for downlink communications, from the first serving cell to the second candidate target cell for uplink communications, or both, in response to the received one or more cell switch commands.

In some examples of the method, user equipment (UEs), and non-transitory computer-readable medium described herein, receiving the one or more cell switch commands may include operations, features, means, or instructions for receiving a first cell switch command indicating to switch to the first candidate target cell for downlink communications and receiving a second cell switch command indicating to switch to the second candidate target cell for uplink communications; or both.

In some examples of the method, user equipment (UEs), and non-transitory computer-readable medium described herein, the first cell switch command, the second cell switch command, or both, includes a respective identifier indicating a respective candidate target cell, a first bit indicating whether to switch to the respective candidate target cell for downlink communications, and a second bit indicating whether to switch to the respective candidate target cell for uplink communications.

In some examples of the method, user equipment (UEs), and non-transitory computer-readable medium described herein, the first cell switch command, the second cell switch command, or both, includes one or more fields operable to indicate either one or more downlink parameters or one or more uplink parameters.

In some examples of the method, user equipment (UEs), and non-transitory computer-readable medium described herein, receiving the one or more cell switch commands may include operations, features, means, or instructions for receiving a first cell switch command indicating the first candidate target cell, the second candidate target cell, or both.

In some examples of the method, user equipment (UEs), and non-transitory computer-readable medium described herein, the first cell switch command includes a first identifier associated with downlink communications and a second identifier associated with uplink communications, and the first identifier indicates the first candidate target cell, the second identifier indicates the second candidate target cell, or both.

Some examples of the method, user equipment (UEs), and non-transitory computer-readable medium described herein may further include operations, features, means, or instructions for receiving one or more second control messages indicating a second set of multiple configurations for a second set of multiple candidate target cells based on moving from a first geographical region to a second geographical region, where one or more of the set of multiple candidate target cells overlap with one or more of the second set of multiple candidate target cells.

Some examples of the method, user equipment (UEs), and non-transitory computer-readable medium described herein may further include operations, features, means, or instructions for performing a set of multiple measurements via a set of multiple signals received from the set of multiple candidate target cells and transmitting one or more reports indicating the set of multiple measurements, where receiving the one or more cell switch commands may be in response to transmitting the one or more reports.

In some examples of the method, user equipment (UEs), and non-transitory computer-readable medium described herein, the one or more cell switch commands indicate a first TCI state associated with the first candidate target cell, a second TCI state associated with the second candidate target cell, or both.

In some examples of the method, user equipment (UEs), and non-transitory computer-readable medium described herein, the one or more cell switch commands indicate one or more parameters associated with the first candidate target cell, associated with the second candidate target cell, or both, and the one or more parameters indicate one or more timing advance values, one or more random access preambles, one or more synchronization signals, one or more random access masks, a quantity of repetitions, or any combination thereof.

In some examples of the method, user equipment (UEs), and non-transitory computer-readable medium described herein, each candidate target cell of the set of multiple candidate target cells may be associated with a respective transmit-receive point (TRP).

A method for wireless communication by a UE is described. The method may include receiving a control message indicating a configuration for a set of multiple candidate target cells corresponding to a virtual cell including the set of multiple candidate target cells, receiving a cell switch command, the cell switch command indicating a first candidate target cell of the set of multiple candidate target cells for use in downlink communications, a second candidate target cell of the set of multiple candidate target cells for use in uplink communications, or both, and switching from a first serving cell to the first candidate target cell for downlink communications, from the first serving cell to the second candidate target cell for uplink communications, or both, in response to the received cell switch command.

A UE for wireless communication is described. The UE may include one or more memories storing processor executable code, and one or more processors coupled with the one or more memories. The one or more processors may individually or collectively be operable to execute the code to cause the UE to receive a control message indicating a configuration for a set of multiple candidate target cells corresponding to a virtual cell including the set of multiple candidate target cells, receive a cell switch command, the cell switch command indicating a first candidate target cell of the set of multiple candidate target cells for use in downlink communications, a second candidate target cell of the set of multiple candidate target cells for use in uplink communications, or both, and switch from a first serving cell to the first candidate target cell for downlink communications, from the first serving cell to the second candidate target cell for uplink communications, or both, in response to the received cell switch command.

Another UE for wireless communication is described. The UE may include means for receiving a control message indicating a configuration for a set of multiple candidate target cells corresponding to a virtual cell including the set of multiple candidate target cells, means for receiving a cell switch command, the cell switch command indicating a first candidate target cell of the set of multiple candidate target cells for use in downlink communications, a second candidate target cell of the set of multiple candidate target cells for use in uplink communications, or both, and means for switching from a first serving cell to the first candidate target cell for downlink communications, from the first serving cell to the second candidate target cell for uplink communications, or both, in response to the received cell switch command.

A non-transitory computer-readable medium storing code for wireless communication is described. The code may include instructions executable by one or more processors to receive a control message indicating a configuration for a set of multiple candidate target cells corresponding to a virtual cell including the set of multiple candidate target cells, receive a cell switch command, the cell switch command indicating a first candidate target cell of the set of multiple candidate target cells for use in downlink communications, a second candidate target cell of the set of multiple candidate target cells for use in uplink communications, or both, and switch from a first serving cell to the first candidate target cell for downlink communications, from the first serving cell to the second candidate target cell for uplink communications, or both, in response to the received cell switch command.

In some examples of the method, user equipment (UEs), and non-transitory computer-readable medium described herein, receiving the cell switch command may include operations, features, means, or instructions for receiving a first cell switch command including a first identifier indicating the first candidate target cell, a second identifier indicating the second candidate target cell, or both.

In some examples of the method, user equipment (UEs), and non-transitory computer-readable medium described herein, the configuration includes a single TCI state pool associated with the set of multiple candidate target cells.

In some examples of the method, user equipment (UEs), and non-transitory computer-readable medium described herein, the configuration includes a set of multiple TCI state pools each associated with a respective candidate target cell of the set of multiple candidate target cells, and the cell switch command includes one or more identifiers indicating one or more candidate target cells and one or more respective TCI state pools.

Some examples of the method, user equipment (UEs), and non-transitory computer-readable medium described herein may further include operations, features, means, or instructions for receiving a second control message indicating a second configuration for a second set of multiple candidate target cells based on moving from a first geographical region to a second geographical region, where one or more of the set of multiple candidate target cells overlap with one or more of the second set of multiple candidate target cells.

Some examples of the method, user equipment (UEs), and non-transitory computer-readable medium described herein may further include operations, features, means, or instructions for performing a set of multiple measurements via a set of multiple signals received from the set of multiple candidate target cells and transmitting one or more reports indicating the set of multiple measurements, where receiving the cell switch command may be in response to transmitting the one or more reports.

In some examples of the method, user equipment (UEs), and non-transitory computer-readable medium described herein, the cell switch command indicates a first TCI state associated with the first candidate target cell, a second TCI state associated with the second candidate target cell, or both.

In some examples of the method, user equipment (UEs), and non-transitory computer-readable medium described herein, the cell switch command indicates one or more parameters associated with the first candidate target cell, associated with the second candidate target cell, or both, and the one or more parameters indicate one or more timing advance values, one or more random access preambles, one or more synchronization signals, one or more random access masks, a quantity of repetitions, or any combination thereof.

In some examples of the method, user equipment (UEs), and non-transitory computer-readable medium described herein, each candidate target cell of the set of multiple candidate target cells may be associated with a respective TRP of the virtual cell.

A method for wireless communication by a network entity is described. The method may include outputting one or more control messages indicating at least one configuration of a set of multiple configurations for a set of multiple candidate target cells and outputting one or more cell switch commands, the one or more cell switch commands indicating a first candidate target cell of the set of multiple candidate target cells for use in downlink communications, a second candidate target cell of the set of multiple candidate target cells for use in uplink communications, or both.

A network entity for wireless communication is described. The network entity may include one or more memories storing processor executable code, and one or more processors coupled with the one or more memories. The one or more processors may individually or collectively be operable to execute the code to cause the network entity to output one or more control messages indicating at least one configuration of a set of multiple configurations for a set of multiple candidate target cells and output one or more cell switch commands, the one or more cell switch commands indicating a first candidate target cell of the set of multiple candidate target cells for use in downlink communications, a second candidate target cell of the set of multiple candidate target cells for use in uplink communications, or both.

Another network entity for wireless communication is described. The network entity may include means for outputting one or more control messages indicating at least one configuration of a set of multiple configurations for a set of multiple candidate target cells and means for outputting one or more cell switch commands, the one or more cell switch commands indicating a first candidate target cell of the set of multiple candidate target cells for use in downlink communications, a second candidate target cell of the set of multiple candidate target cells for use in uplink communications, or both.

A non-transitory computer-readable medium storing code for wireless communication is described. The code may include instructions executable by one or more processors to output one or more control messages indicating at least one configuration of a set of multiple configurations for a set of multiple candidate target cells and output one or more cell switch commands, the one or more cell switch commands indicating a first candidate target cell of the set of multiple candidate target cells for use in downlink communications, a second candidate target cell of the set of multiple candidate target cells for use in uplink communications, or both.

In some examples of the method, network entities, and non-transitory computer-readable medium described herein, outputting the one or more cell switch commands may include operations, features, means, or instructions for outputting a first cell switch command indicating to switch to the first candidate target cell for downlink communications and outputting a second cell switch command indicating to switch to the second candidate target cell for uplink communications; or both.

In some examples of the method, network entities, and non-transitory computer-readable medium described herein, the first cell switch command, the second cell switch command, or both, includes a respective identifier indicating a respective candidate target cell, a first bit indicating whether to switch to the respective candidate target cell for downlink communications, and a second bit indicating whether to switch to the respective candidate target cell for uplink communications.

In some examples of the method, network entities, and non-transitory computer-readable medium described herein, the first cell switch command, the second cell switch command, or both, includes one or more fields operable to indicate either one or more downlink parameters or one or more uplink parameters.

In some examples of the method, network entities, and non-transitory computer-readable medium described herein, outputting the one or more cell switch commands may include operations, features, means, or instructions for outputting a first cell switch command indicating the first candidate target cell, the second candidate target cell, or both.

Some examples of the method, network entities, and non-transitory computer-readable medium described herein may further include operations, features, means, or instructions for switching a first UE from a first serving cell to the first candidate target cell for downlink communications, from the first serving cell to the second candidate target cell for uplink communications, or both, in response to outputting the one or more cell switch commands.

A method for wireless communication by a network entity is described. The method may include outputting a control message indicating a configuration for a set of multiple candidate target cells corresponding to a virtual cell including the set of multiple candidate target cells and outputting a cell switch command, the cell switch command indicating a first candidate target cell of the set of multiple candidate target cells for use in downlink communications, a second candidate target cell of the set of multiple candidate target cells for use in uplink communications, or both.

A network entity for wireless communication is described. The network entity may include one or more memories storing processor executable code, and one or more processors coupled with the one or more memories. The one or more processors may individually or collectively be operable to execute the code to cause the network entity to output a control message indicating a configuration for a set of multiple candidate target cells corresponding to a virtual cell including the set of multiple candidate target cells and output a cell switch command, the cell switch command indicating a first candidate target cell of the set of multiple candidate target cells for use in downlink communications, a second candidate target cell of the set of multiple candidate target cells for use in uplink communications, or both.

Another network entity for wireless communication is described. The network entity may include means for outputting a control message indicating a configuration for a set of multiple candidate target cells corresponding to a virtual cell including the set of multiple candidate target cells and means for outputting a cell switch command, the cell switch command indicating a first candidate target cell of the set of multiple candidate target cells for use in downlink communications, a second candidate target cell of the set of multiple candidate target cells for use in uplink communications, or both.

A non-transitory computer-readable medium storing code for wireless communication is described. The code may include instructions executable by one or more processors to output a control message indicating a configuration for a set of multiple candidate target cells corresponding to a virtual cell including the set of multiple candidate target cells and output a cell switch command, the cell switch command indicating a first candidate target cell of the set of multiple candidate target cells for use in downlink communications, a second candidate target cell of the set of multiple candidate target cells for use in uplink communications, or both.

In some examples of the method, network entities, and non-transitory computer-readable medium described herein, outputting the cell switch command may include operations, features, means, or instructions for outputting a first cell switch command including a first identifier indicating the first candidate target cell, a second identifier indicating the second candidate target cell, or both.

In some examples of the method, network entities, and non-transitory computer-readable medium described herein, the configuration includes a single TCI state pool associated with the set of multiple candidate target cells, or the configuration includes a set of multiple TCI state pools each associated with a respective candidate target cell of the set of multiple candidate target cells, where the cell switch command includes one or more identifiers indicating one or more candidate target cells and one or more respective TCI state pools.

Some examples of the method, network entities, and non-transitory computer-readable medium described herein may further include operations, features, means, or instructions for switching a first UE from a first serving cell to the first candidate target cell for downlink communications, from the first serving cell to the second candidate target cell for uplink communications, or both, in response to outputting the cell switch command.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports cell switch command for decoupled downlink and uplink operation in accordance with one or more aspects of the present disclosure.

FIG. 2 shows an example of a network architecture that supports cell switch command for decoupled downlink and uplink operation in accordance with one or more aspects of the present disclosure.

FIG. 3 shows an example of a wireless communications system that supports cell switch command for decoupled downlink and uplink operation in accordance with one or more aspects of the present disclosure.

FIG. 4 shows an example of a process flow that supports cell switch command for decoupled downlink and uplink operation in accordance with one or more aspects of the present disclosure.

FIGS. 5A and 5B show examples of message formats that support cell switch command for decoupled downlink and uplink operation in accordance with one or more aspects of the present disclosure.

FIG. 6 shows an example of a process flow that supports cell switch command for decoupled downlink and uplink operation in accordance with one or more aspects of the present disclosure.

FIG. 7 shows an example of a message format that supports cell switch command for decoupled downlink and uplink operation in accordance with one or more aspects of the present disclosure.

FIGS. 8 and 9 show block diagrams of devices that support cell switch command for decoupled downlink and uplink operation in accordance with one or more aspects of the present disclosure.

FIG. 10 shows a block diagram of a communications manager that supports cell switch command for decoupled downlink and uplink operation in accordance with one or more aspects of the present disclosure.

FIG. 11 shows a diagram of a system including a device that supports cell switch command for decoupled downlink and uplink operation in accordance with one or more aspects of the present disclosure.

FIGS. 12 and 13 show block diagrams of devices that support cell switch command for decoupled downlink and uplink operation in accordance with one or more aspects of the present disclosure.

FIG. 14 shows a block diagram of a communications manager that supports cell switch command for decoupled downlink and uplink operation in accordance with one or more aspects of the present disclosure.

FIG. 15 shows a diagram of a system including a device that supports cell switch command for decoupled downlink and uplink operation in accordance with one or more aspects of the present disclosure.

FIGS. 16 through 19 show flowcharts illustrating methods that support cell switch command for decoupled downlink and uplink operation in accordance with one or more aspects of the present disclosure.

### DETAILED DESCRIPTION

In some networks, a user equipment (UE) may be configured with lower-layer triggered (LTM) mobility, in which the UE may receive a layer 1(L 1 ) or layer 2 (L2) message, such as a medium access control (MAC) control element (MAC-CE), which may instruct the UE to perform a cell switch. In some cases, a UE may determine a cell to which the UE may switch based on one or more metrics, such as a highest receive power (e.g., a Reference Signal Received Power (RSRP)). However, a cell with a highest receive power may have relatively poor uplink performance compared to other cells of a set of cells, resulting in inefficiency in communications. For example, the UE may measure a highest RSRP for a given candidate cell, but the cell having the highest RSRP based on measured downlink signaling may support relatively poor uplink performance compared to another cell due to differences between capability, load, available resources, or path loss, among other differences between the two cells. In such examples, switching to the candidate cell having the highest RSRP may result in relatively high performance downlink signaling and relatively low performance uplink signaling. Further, some systems may support switching to a cell with relatively low downlink performance if the uplink performance of the high RSRP cell fails to satisfy one or more metrics. In such examples, cell switching based on such metrics, or cell switching for both uplink and downlink signaling, may result in inefficient communications, added latency, loss of data, and poor quality of service (QoS). Thus, opportunities may exist for additional signaling and configurations.

Techniques described herein support protocols, configurations, and messaging enabling separate handover, or cell switch, for uplink and downlink communications. For example, in a first scenario, an LTM framework may define separate configurations for different transmit-receive points (TRPs) or other network entities and related cells (e.g., serving cells, target candidate cells), and may implement one or more message formats (e.g., a MAC-CE format) that may define an uplink cell and downlink cell separately (e.g., using separate identifiers). For example, a UE may receive control signaling (e.g., one or more control messages) indicating multiple separate configurations for different TRPs or other network entities and related cells, and may receive one or more cell switch commands that may define an uplink cell and downlink cell separately. That is, each cell may be individually configured (e.g., where each cell is defined as an uplink cell, a downlink cell, or both), and a cell switch command may indicate that the UE is to switch a downlink cell (e.g., from a first cell supporting downlink signaling to a second cell supporting downlink signaling), or is to switch an uplink cell (e.g., from a first cell supporting uplink signaling to a second cell supporting uplink signaling), or both. Additionally, or alternatively, a switch may involve switching from a cell supporting both downlink and uplink to one cell for downlink and another cell for uplink, or vice versa. In some examples, separate cell switch commands may indicate different cells for uplink and downlink, or a single cell switch command may include multiple fields to indicate uplink cells, downlink cells, or both. In a second scenario, an LTM framework may define a virtual cell with a single configuration for multiple TRPs, or other network entities, that may each support downlink, uplink, or both. For example, the UE may receive a control message defining the virtual cell. In some examples, one or more TCI state pools may be shared across TRPs to support backwards compatible MAC-CE message formats, or may be transmit-receive point (TRP)-specific to reduce overhead in transmissions due to frequent mobility. Further, a network may support network entities with diverse support for uplink communications, downlink communications, or both.

Supporting decoupled uplink and downlink operation at a UE may increase an efficiency in communications by enabling separate cell selection based on uplink or downlink performance, while providing a more flexible handover structure. Additionally, or alternatively, by implementing a message format in a framework involving separate configurations per TRP or cell, a full TCI pool size may be utilized per TRP while reducing overhead due to reconfiguration during UE mobility and handover. Additionally, or alternatively, implementing a framework involving a virtual cell with a single configuration may enable backwards compatibility with one or more message formats.

Aspects of the disclosure are initially described in the context of wireless communications systems. Aspects of the disclosure are further illustrated by and described with reference to wireless communications systems, message formats, and process flows that relate to cell switch command for decoupled downlink and uplink operation. Aspects of the disclosure are further illustrated by and described with reference to apparatus diagrams, system diagrams, and flowcharts that relate to cell switch command for decoupled downlink and uplink operation.

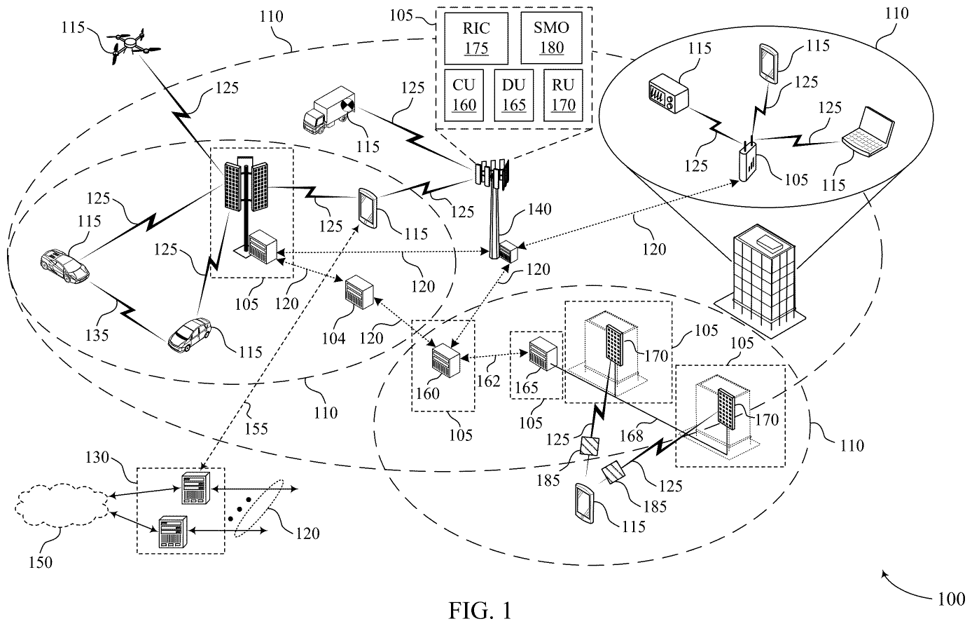

FIG. 1 shows an example of a wireless communications system 100 that supports cell switch command for decoupled downlink and uplink operation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104. In the case of the techniques described herein applied in the context of a disaggregated RAN architecture, one or more components of the disaggregated RAN architecture may be configured to support cell switch command for decoupled downlink and uplink operation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs. The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCI), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices. Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, a Radio Resource Control (RRC) layer may provide establishment, configuration, and maintenance of an RRC connection between a UE 115 and a network entity 105 or a core network 130 supporting radio bearers for user plane data. A PHY layer may map transport channels to physical channels.

In some examples, the wireless communications system 100 may support LTM mobility and L1 or L2 messaging (e.g., MAC-CE) to indicate cell switch for UEs 115. Further, a UE 115 may determine to switch to a cell based on one or more metrics, such as a highest receive power (e.g., a Reference Signal Received Power (RSRP)). However, a cell with a highest receive power may perform worse in uplink compared to other cells of a set of cells, and thus cell switching based on such metrics, or cell switching for both uplink and downlink signaling, may result in inefficient communications, added latency, loss of data, and poor quality of service (QoS).

Techniques described herein may support protocols, configurations, and messaging enabling separate handover, or cell switch, for uplink and downlink communications in the wireless communications system 100. For example, in a first scenario, the wireless communications system 100 may support an LTM framework that may define separate configurations for candidate cells, and may implement one or more message formats (e.g., a MAC-CE) that may define an uplink cell and downlink cell separately (e.g., using separate identifiers). For example, a UE 115 may receive one or more cell switch commands 185, where separate cell switch commands 185 may indicate different cells for uplink and downlink, or a single cell switch command 185 may include multiple fields to indicate uplink and downlink cells. That is, each cell may be individually configured (e.g., where each cell is defined as an uplink cell, a downlink cell, or both), and a cell switch command may indicate that the UE is to switch a downlink cell (e.g., from a first cell supporting downlink signaling to a second cell supporting downlink signaling), or is to switch an uplink cell (e.g., from a first cell supporting uplink signaling to a second cell supporting uplink signaling), or both. Additionally, or alternatively, a switch may involve switching from a cell supporting both downlink and uplink to one cell for downlink and another cell for uplink, or vice versa.

In some examples, the wireless communications system 100 may support an LTM framework that may define a virtual cell including multiple TRPs, where the virtual cell may include a single configuration. In a virtual cell, a UE 115 may receive one or more cell switch commands 185 according to a message format that may indicate to switch to an uplink cell (e.g., a first TRP) and a downlink cell (e.g., a second TRP) of the virtual cell using the single configuration. In some examples, one or more TCI state pools may be shared across TRPs to support backwards compatible MAC-CE message formats, or may be TRP-specific to reduce overhead in transmissions due to frequent mobility. Further, the wireless communications system 100 may support network entities 105 (e.g., base stations 140, CUs 160-a, DUs 165-a, RUs 170-a, among any form of network entity 105) with diverse support for uplink communications, downlink communications, or both. Supporting decoupled uplink and downlink operation at a UE 115 may increase an efficiency in communications by enabling separate cell selection based on uplink or downlink performance, while providing a more flexible handover structure.

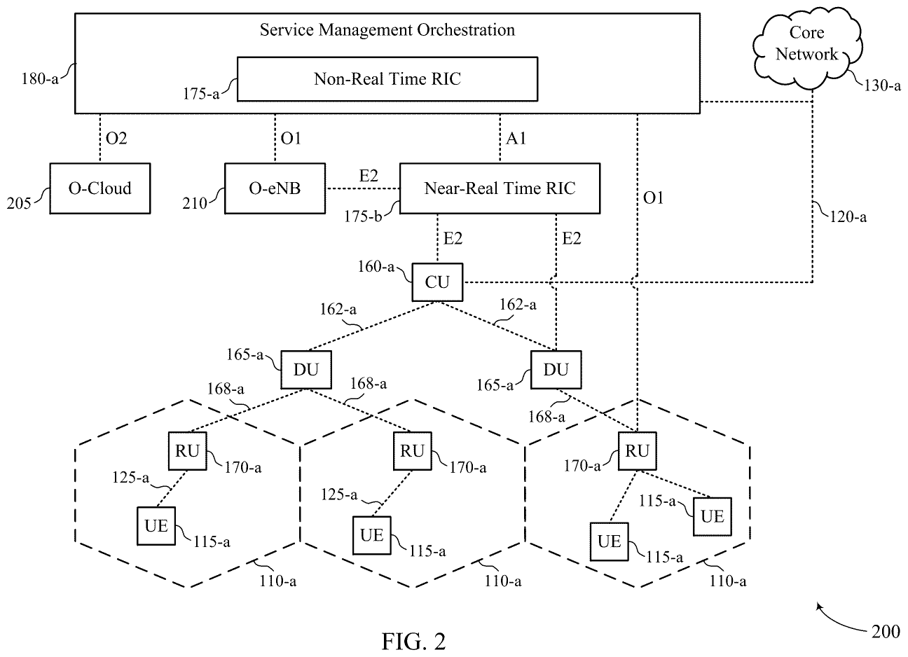

FIG. 2 shows an example of a network architecture 200 (e.g., a disaggregated base station architecture, a disaggregated RAN architecture) that supports cell switch command for decoupled downlink and uplink operation in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O 1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

Techniques described herein may support protocols, configurations, and messaging enabling separate handover, or cell switch, for uplink and downlink communications in the network architecture 200. For example, the network architecture 200 may support an LTM framework that may define separate configurations for candidate cells and one or more message formats for cell switch commands 185 received at UEs 115-a (e.g., from an RU 170-a), or an LTM framework that may define a virtual cell that includes multiple TRPs as described herein. The network architecture 200 may further support CUs 160-a, DUs 165-a, RUs 170-a, among any form of network entity 105, with diverse support for uplink communications, downlink communications, or both.

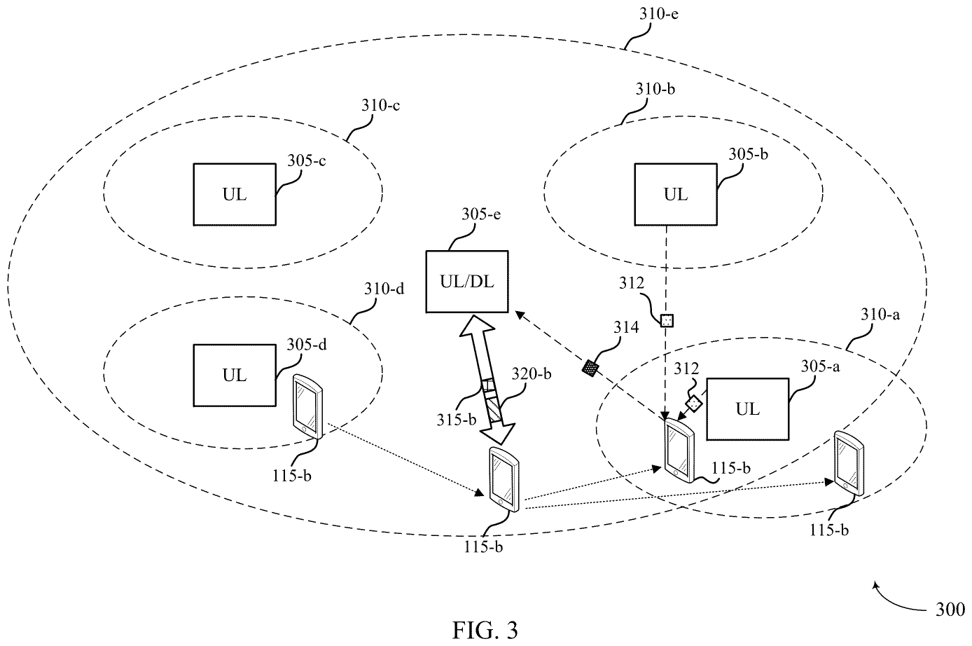

FIG. 3 shows an example of a wireless communications system 300 that supports cell switch command for decoupled downlink and uplink operation in accordance with one or more aspects of the present disclosure. In some examples, the wireless communications system 300 may implement or be implemented by aspects of the wireless communications system 100 and the network architecture 200. For example, the wireless communications system 300 may include one or more UEs 115, including a UE 115-b, and one or more network entities 305, which may represent various UEs 115 and network entities 105 described in FIG. 1. In some examples, the UEs 115 and network entities 305 may support signaling and configurations for combined or separated uplink and downlink communications as described herein.

In some examples, the wireless communications system 300 may support L1 and L2 mobility. For example, the wireless communications system 300 may include one or more cells 310, which may include a set of preconfigured candidate target cells. For example, the wireless communications system 300 may include cells 310-a, 310-b, 310-c, and 310-d with corresponding network entities 305-a, 305-b, 305-c, and 305-d (e.g., TRPs), respectively. During L1/L2 mobility (e.g., geographical movement between cells), a UE 115 may receive inter-cell reference signals and may measure L1/L2 signaling from candidate target cells, and may report such measurements. In some examples, one or more devices of a network may receive reports of the measurements and indicate to the UE 115 to switch cells, or the UE 115 may determine to switch cells based on the measurements. In some cases, one or more devices of the wireless communications system 300 may use L1 triggered mobility for Special Cells (SpCells) via L1/L2 signaling based on L1 measurements.

In some examples, in LTM, a network entity 305 may configure a connected UE 115 to measure different handover candidate cells, which may be at (e.g., may operate using) different frequencies. For example, in a candidate cell measurement report, the UE 115 may report L cells where L (e.g., L=1, 2, 3, 4) may be based on a UE capability. The UE 115 may determine cells that are to be reported. In the report, UE 115 may prioritize reporting cells with relatively high receive power, such as a relatively high L1 Reference Signal Received Power (RSRP). However, such cells may have worse uplink coverage compared to other cells, or may be incapable of supporting a threshold (e.g., mandated) uplink performance (e.g., performance associated with power, throughput, or latency). For example, uplink control may fail due to blockage in transmitting to a candidate target cell (e.g., a cell with better downlink performance) causing a UE 115 to select a cell with worse downlink performance but which may support a defined uplink metric.

In some examples, using a same cell 310 for both uplink and downlink communications may result in poor performance in another transmission direction, causing inefficiency in communication. For example, a target cell, beam, or TRP that may have a highest downlink throughput may not support a highest uplink throughput. For example, an uplink transmit power may be different across different cells, beams, or TRPs. In some cases, power backoff from maximum power extrapolation (MPE) in a cell with a highest downlink throughput may reduce uplink throughput compared to a cell without MPE that may have relatively improved uplink throughput. Additionally, or alternatively, a lower uplink transmit power in cell with a highest downlink throughput or performance may be caused by power sharing with other FRs or RATs for that cell (e.g., different FRs or RATs overlap the cell). However another cell that is well separated from overlapping bands, with dedicated power amplification and no sharing of uplink transmit power may provide improved uplink performance even with lower downlink performance.

Additionally, or alternatively, cell load, available resources, transmission and reception capabilities, and hardware may be different for downlink and uplink in a cell. For example, uplink coverage may be in some cases be weaker than downlink due to imbalanced maximum transmission power, as a UE 115 may have a weaker transmission power compared to a network entity 305. Further, in TDD, a slot/symbol pattern, maximum downlink/uplink layers, individual downlink/uplink BWPs, among other aspects may lead to asymmetric uplink and downlink performance after handover or cell switch. In some examples, such as in FDD, cell bandwidth for downlink and uplink or time-frequency-spatial resources for uplink may be different from downlink. Additionally, or alternatively, a target cell may have higher downlink load than uplink load and the uplink or downlink loads may vary dynamically, leading to poor QoS after a cell switch. Additionally, or alternatively, downlink and uplink pathlosses may be different (e.g., for FDD operation). Thus, for various reasons, selection of a candidate cell based on measured receive power (e.g., RSRP), may result in selection of a cell having a best (e.g., highest) RSRP, but poor uplink quality, which may result in inefficient use of available system resources, decreased reliability of wireless communications, failed transmissions, increased signaling overhead and cell switching, increased system latency, and decreased user experience.

As described herein, the wireless communications system 300 may support various LTM frameworks, configurations, and signaling for decoupled uplink and downlink communications including decoupled uplink and downlink cell selection. For example, a network may select separate target cells, beams, or TRPs for downlink and uplink using various network entities 305 (e.g., TRPs). In some cases, such decoupling may enable communication using network entities 305 that may support either uplink or downlink communications (e.g., but not both). For example, a network entity 305-e may be a TRP supporting both downlink and uplink communications (e.g., a DU) while the multiple network entities 305-a through 305-d may be uplink TRPs (e.g., TRPs primarily or only supporting uplink communications). Additionally, or alternatively, the wireless communication system 300 may support downlink TRPs (e.g., TRPs primarily or only supporting downlink communications). In some cases, the wireless communications system 300 may include a potential for thin downlink transmission per uplink-only TRP (e.g., supporting synchronization signal block (SSB) or channel state information reference signal (CSI-RS) for TRP measurement), but such TRPs may lack support for downlink data transfer. The uplink TRPs may in some cases be located in a coverage of the network entity 305-e for uplink coverage extension, and may reduce operation cost compared with using TRPs that support both downlink and uplink operation. In some cases, the UE 115-b may report one or more uplink-only candidate TRPs based on corresponding downlink reference signal measurement. For example, the UE 115-b may receive and measure one or more signals 312 (e.g., reference signals) and may transmit one or more reports 314, where cell switching may be based on the reports 314.

In some examples, the wireless communications system 300 may include differences in SCell activation and deactivation based on uplink and downlink TRPs. For example, in the wireless communications system 300, one cell 310 or network entity 305 (e.g., TRP) may be downlink-only and another cell 310 or network entity 305 (e.g., TRP) may be uplink-only. This may be different than other systems involving carrier aggregation, which may involve collocated deployments in some networks, where a network may configure SCells as non-overlapping in frequency. For example, in such networks, PCells may support both downlink and uplink resources, while SUL may support uplink but may utilize an anchor that has both downlink and uplink support.

In some examples, utilizing uplink TRPs and downlink TPRs may enable the UE 115-b to switch between cells for uplink and downlink separately (e.g., to perform a cell switch from a first uplink cell to a second uplink cell, or from a first downlink cell to a second downlink cell, or both). For example, during mobility, the UE 115-b may switch from a serving cell of the network entity 305-d to a cell of the network entity 305-a for uplink while remaining connected with the network entity 305-e for downlink. Additionally, or alternatively, the UE 115-b may switch from the serving cell of the network entity 305-e to another network entity 305 for downlink while remaining connected with the network entity 305-a for uplink.

In some examples, the wireless communications system 300 may define identifiers, such as physical cell identifiers (PCIs), and cell configurations for supporting separate TRPs or cells for downlink and uplink, where a PCI may indicate separate TRPs for downlink and uplink, respectively, in one or more cell switch commands based on a PCI definition. For example, one or more devices of the wireless communications system 300 may configure a subset of the TRPs as LTM candidates. However, when moving between coverage areas, the UE 115-b may cause one or more TRPs to change among a current quantity of qualifying TRPs configured as candidates. That is, the UE 115 may include a quantity of potential TRPs that may satisfy one or more metrics (e.g., be within a range, have a high enough RSRP) for consideration as candidate cells. As the UE 115 moves from one geographical area to another, the UE 115 or a network entity 305 may remove one or more TRPs in the set as they fail to satisfy the one or more metrics (e.g., as the fall out of a defined range, as RSRP drops) and may add additional TRPs (e.g., TRPs within an updated range of coverage, TRPs with a higher RSRP). If carrier aggregation is supported, along with various types of uplink TRPs, downlink TRPs, and uplink/downlink TRPs, a quantity of potential combinations of connections may be relatively large in some scenarios, increasing processing and power usage.

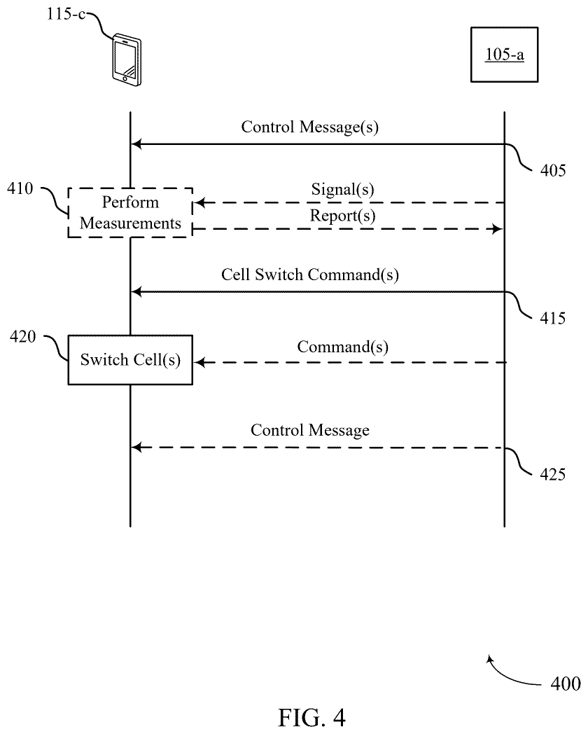

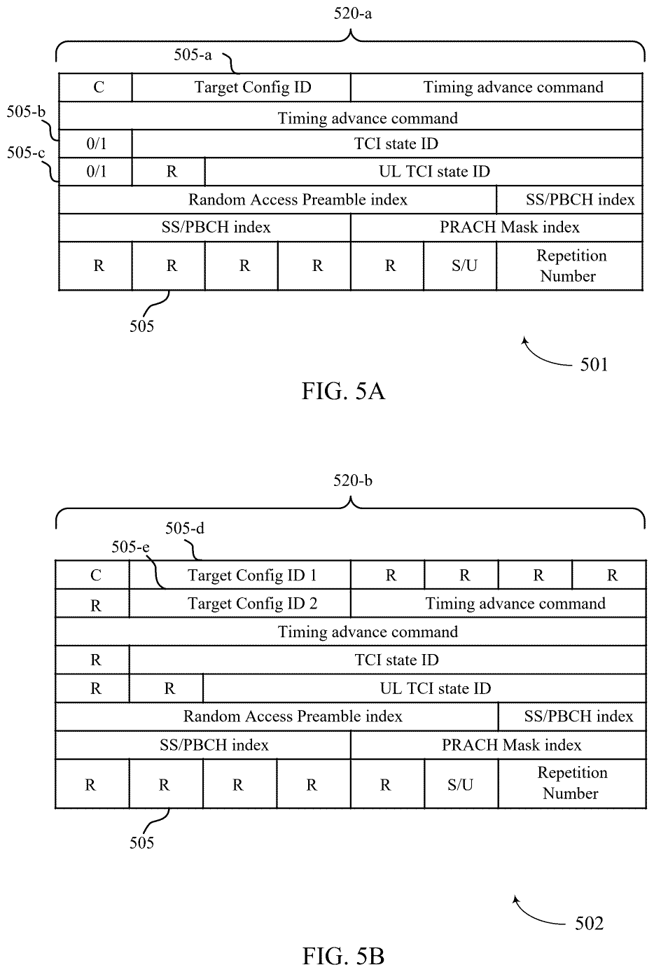

In a first scenario (e.g., as described in greater detail with reference to FIGS. 4, 5A, and 5B), the wireless communications system 300 may define a PCI per TRP within a network. For example, the UE 115-b may receive one or more control messages 315-b (or other control signaling) that may indicate one or multiple configurations corresponding to the different network entities 305, or TPRs and corresponding cells with PCIs. In some examples (e.g., FR2), this configuration may define one TRP as one cell under single TRP operation. In such a case, across different TRPs, cell switch may refer to changing a serving cell configuration associated with each TRP.

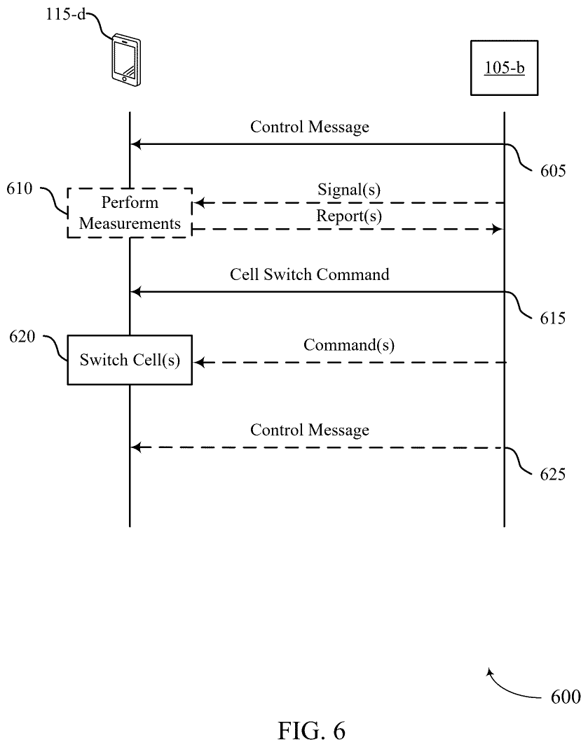

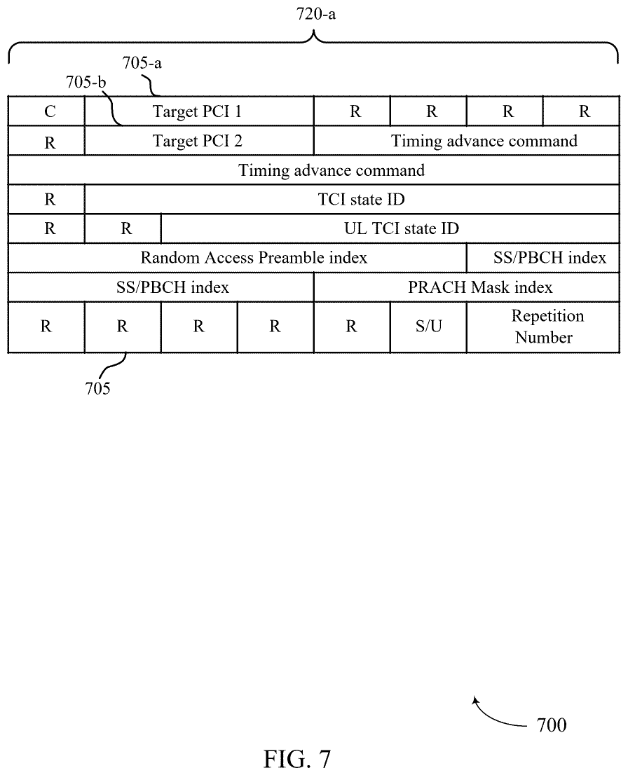

Additionally, or alternatively, in a second scenario (e.g., as described in greater detail with reference to FIGS. 6 and 7), the wireless communications system 300 may define PCIs to have a same configuration in a virtual cell. For example, the control message 315-b may indicate a single configuration in a virtual cell. In some cases, the network entity 305-e (e.g., a DU or other network entity) and the cell 310-e may act as a single virtual cell that may cover a relatively large geographical area including multiple TRPs. In some cases, the network entity 305-e may control the multiple TRPs. In some cases, an associated PCI may identify each TRP (e.g., the network entities 305-a through 305-d). The single candidate cell configuration may be the same across TRPs and may change relatively little when TRPs are switched into and out of the cell. For example, in LTM, such switching may involve each candidate cell having an identical candidate cell configuration. In some examples, individual TRPs (e.g., RUs) may collect downlink and uplink traffic and route the traffic through the network entity 305-e managing a related area. In some cases, an FR1 TRP may have relatively limited uplink resources, and FR2 TRPs may in some cases be separate (e.g., not collocated) from FR1 TRPs. Further, unlike supplementary uplink (SUL), uplink TRPs may be separate from a downlink/uplink TPR or PCell. In some examples, the cell 310-e, for a same FR, may involve one large macro cell and multiple smaller (e.g., micro/pico) cells. For downlink, to decrease broadcast channels, a network may send signals via a macro cell, but may switch between different smaller cells for uplink offloading.

In some examples, the wireless communications system 300 may support dynamic switching between configurations according to the first scenario and the second scenario. For example, devices of the wireless communications system 300 may utilize separate configurations for TRPs or a single configuration for a virtual cell based on a quantity of TRPs, a frequency of change in TRPs or cells within range of a UE 115, or based on a configuration or capability of one or more UEs 115 or network entities 305. In some examples, the network may instruct one or more cells or TRPs to switch between the first scenario and the second scenario.

In some examples, the network may transmit one or more messages for LTM procedures, and such messages may support uncoupled uplink and downlink cell switching. For example, to support decoupling of uplink and downlink operation, the UE 115 may receive one or more cell switch commands 320-b (e.g., MAC-CEs) that may indicate which cell 310 (e.g., candidate cell) to switch to. In some cases, the UE 115-b may receive a MAC-CE for uplink configuration and a MAC-CE for downlink configuration, or may receive a MAC-CE indicating cells for both uplink and downlink. In some examples, such MAC-CEs may further indicate one or more identifiers associated with the cells and TRPs. For example, an LTM cell switch MAC-CE command for a UE 115 sent on a serving cell may contain a target configuration ID, which may in some cases indicate an index of a candidate target configuration to apply (e.g., corresponding to an RRC information element ltm-CandidateId minus 1 for cell switch, with a quantity of bits, such as 3 bits indicating up to 8 targets). Further, an LTM Candidate information element may indicate a PCI (e.g., ltm-CandidatePCI).

In some examples, mechanism and procedures may be supported for L1/L2 based inter-cell mobility for mobility latency reduction. For example, the wireless communications system 300 may support configuration and maintenance for multiple candidate cells to allow relatively fast application of configurations for candidate cells and a dynamic switch mechanism among candidate serving cells (e.g., including SpCell and secondary cell (SCell)) based on L1/L2 signaling. Further, for inter-cell beam management, L1 measurement and reporting and beam indication may be supported. In some examples, the wireless communications system 300 may support timing advance management, CU-DU interface signaling to support L1/L2 mobility, and may involve FR2 specific configurations. Further, a procedure of L1/L2 based inter-cell mobility may be applicable to standalone UE 115 communications, carrier aggregation and NR dual-connectivity (DC) involving serving cell change within one configured grant, intra-DU cases and intra-CU inter-DU cases (e.g., applicable for standalone and carrier aggregation configurations), both intra-frequency and inter-frequency cases, and both FR1 and FR2. Further, source and target cells (e.g., cells 310) may be synchronized or non-synchronized.

Additionally, or alternatively, in LTM, a network entity 305 (e.g., a gNB) may signal a UE 115 to perform LTM cell switch by sending the LTM cell switch command MAC-CE. In some cases, the cell switch command may indicate an LTM candidate configuration that the network entity may previously prepare and provide to the UE 115 through RRC signaling. When configured by a network, one or more commands or other signaling may activate TCI states of one or multiple cells that are different from a current serving cell to allow a UE 115 to have downlink synchronization with LTM candidate cells, and may enable lower latency for cell switch. In some cases, a serving cell of a UE 115 may signal or initiate acquisition of a timing advance value for candidate cells. In some cases, the serving cell may provide a configured grant in an LTM candidate cell configuration. Single cell switch (e.g., from one TRP to another TRP), as well as carrier aggregation may be supported. For example, a UE 115 may switch from a combination of cells to another combination of cells. In some cases, LTM in the wireless communications system 300 may also support primary cell (PCell) change in non-carriage aggregation cases with non-DC, as well as PCell and SCell(s) change in carrier aggregation.

For example, for LTM preparation, a UE 115 may be in RRC_CONNECTED mode and may transmit a measurement report. A gNB (or other network entity 105 or 305) may perform LTM candidate preparation and transmit an RRC reconfiguration indicating the LTM candidate cell configuration, where the UE 115 may respond with an RRC reconfiguration complete message. During early sync, the UE 115 and the gNB may perform downlink synchronization with candidate cells and uplink synchronization with candidate cells. During LTM cell switch execution, the UE 115 may transmit an L1 measurement report, the gNB may perform an LTM decision, and the gNB may transmit a cell switch command (e.g., a MAC-CE). The UE 115 may detach from a source and may apply the target configuration, and may in some cases perform a RACH procedure with the gNB. In some cases, the UE 115 and the gNB may perform one or more procedure or signaling associated with LTM cell switch completion.

FIG. 4 shows an example of a process flow 400 that supports cell switch command for decoupled downlink and uplink operation in accordance with one or more aspects of the present disclosure. In some examples, the process flow 400 may implement or be implemented by aspects of the wireless communications systems 100 and 300 and the network architecture 200. For example, the process flow 400 may include one or more UEs 115, including a UE 115-c, in communication with one or more network entities 105, including a network entity 105-a (e.g., which may be an example of other network entities, such as a network entity 305), that may support messaging and configurations for decoupled uplink and downlink operation.

In the following description of the process flow 400, the operations may be performed (such as reported or provided) in a different order than the order shown, or the operations performed by the example devices may be performed in different orders or at different times. Some operations also may be omitted from the process flow 400, or other operations may be added to the process flow 400. Further, although some operations or signaling may be shown to occur at different times for discussion purposes, these operations may actually occur at the same time or at least partially concurrently. In some examples, the network entity 105-a may represent any network entity 105 or 305 described herein, such as a TRP. The network entity 105-a may be implemented in a disaggregated architecture, and may represent, or include, one or more CUs 160, DUs 165, RUs 170, RICs 175, SMO systems 180, or any combination thereof.

In some examples, the process flow 400 may illustrate operations involving separated configurations for separate TRPs or cells as described herein. For example, a network including the network entity 105-a and the UE 115-c may include an LTM definition that may involve defining separate candidate cell configurations for each TRP of a quantity of TRPs. At 405, the UE 115-c may receive, and the network entity 105-a may output, control signaling (e.g., one or more control messages) indicating a set of multiple configurations for a set of multiple candidate target cells. In some cases, each candidate target cell of the set may be associated with a respective TRP. For example, each PCI may have a separate cell configuration, and each TRP of the network may be treated as a different cell. In some examples, at 410, the UE 115-c may perform a set of multiple measurements via a set of multiple signals received from the set of multiple candidate target cells (e.g., from the network entity 105-a or from any other TRP or network entity of a set of candidate cells). The UE 115-c may also transmit one or more reports indicating the set of multiple measurements (e.g., to the network entity 105-a, to one or more TRPs).

At 415, the UE 115-c may receive, and the network entity 105-a may output, one or more cell switch commands (e.g., cell switch commands 320). In some cases, the one or more cell switch commands may indicate a first candidate target cell of the set of multiple candidate target cells for use in downlink communications, a second candidate target cell of the set of multiple candidate target cells for use in uplink communications, or both. Receiving the one or more cell switch commands may also be in response to the one or more reports.

At 420, the UE 115-c may switch cells in response to the received one or more cell switch commands. For example, the UE 115-c may switch from a first serving cell to the first candidate target cell for downlink communications, from the first serving cell to the second candidate target cell for uplink communications, or both. For example, the UE 115-c may switch from a serving cell supporting downlink and uplink communications to a first cell for downlink communications (e.g., a downlink-only cell with a corresponding configuration) and to a second cell for uplink communications (e.g., an uplink-only cell with a corresponding configuration) as described herein with respect to FIGS. 1-3. The one or more cell switch commands may also indicate one or more TCI states associated with the first and second candidate target cells, as well as one or more parameters as discussed in further detail with respect to FIGS. 5A and 5B.

At 425, in some examples, the UE 115-c may receive one or more second control messages indicating a second set of multiple configurations for a second set of multiple candidate target cells based on moving from a first geographical region to a second geographical region. For example, one or more cells may move out of a range for access associated with the UE 115-c based on UE mobility, where one or more of the set of multiple candidate target cells may remain in range of the UE and may overlap with one or more of the second set of multiple candidate target cells. Further, the network entity 105-a may perform one or more operations to switch the UE 115-c between one or more cells, for example, via one or more commands.

In some examples, the cell switch may involve one cell used as a downlink cell and another cell used as an uplink cell after the cell switch. Additionally, or alternatively, there may be one serving cell (e.g., logical serving cell) before the switch, where a physical entity used for downlink and for uplink before the switch may be the same entity or separate entities. Further, in some cases, there may be separate cells (e.g., one for uplink and one for downlink) before the switch.

In some cases, utilizing separate configurations for separate cells may enable a full TCI state pool size (e.g., up to 128 TCI states) to be reused per TRP. Additionally, or alternatively, a relatively low RRC signaling overhead may result when a relatively small quantity of TRPs are updated due to UE mobility. For example, if the UE 115-c moves, resulting in one or more TRPs moving out of range and one or more additional TRPs moving within range for use in a set of candidate target cells, then the network entity 105-a (or another device) may signal RRC signaling that may indicate configurations for the additional TRPs. Thus, if a relatively small quantity of TRPs are introduced, the signaling may be relatively low. In some examples, a network or UE may implement one or more MAC-CE formats as described herein.

FIGS. 5A and 5B show examples of message formats 501 and 502 that support cell switch command for decoupled downlink and uplink operation in accordance with one or more aspects of the present disclosure. In some examples, the message formats 501 and 502 may implement or be implemented by aspects of the wireless communications systems 100 and 300, the network architecture 200, and the process flow 400. For example, the message formats 501 and 502 may be message formats for one or more cell switch commands 520 received at the UE 115-c which may represent one or more cell switch commands 185 or 320 described with respect to FIGS. 1-3.

In some examples, the message formats 501 and 502 may illustrate a format for a cell switch command 520-a and a cell switch command 520-b (e.g., cell switch commands 320 as described with respect to FIG. 3), respectively, such as a MAC-CE. In some examples, a cell switch command 520 may include one or more fields 505, where each field may include one or more bits representing various data and control information. For example, fields 505 of a cell switch command 520 may indicate various parameters associated with one or more candidate target cells, such as one or more parameters indicating one or more timing advance values (e.g., one or more Timing Advance Command fields), one or more random access preambles (e.g., a Random Access Preamble index field), one or more synchronization signals (e.g., one or more SS/PBCH index fields), one or more random access masks (e.g., one or more PRACH Mask index fields), a quantity of repetitions (e.g., a Repetition Number field), among other fields. Further, one or more fields 505 of a cell switch command 520 may be a reserved field (e.g., an “R” field), a C field indicating a presence of contention-free Random Access Resources fields, an S/U field indicating if a supplemental uplink is configured, or the like. In some examples, the content of some or all additional fields in the MAC-CE may correspond to one of the candidate cells indicated by the MAC-CE (e.g., the additional fields may correspond to uplink parameters for the uplink candidate cell indicated by the cell ID or target configuration ID).

In some examples, both FIGS. 5A and 5B may illustrate message formats in accordance with an LTM definition defining separate candidate cell configurations for each TRP as described with respect to FIG. 4. For example, FIGS. 5A and 5B may both illustrate defining a PCI-1 for a downlink PCell (e.g., a PCell defined for a TRP including a first configuration) and a PCI-2 for an uplink PCell (e.g., a PCell defined for another TRP and a second configuration).

In the example of FIG. 5A, for indicating separate TRPs for downlink and uplink, respectively, the cell switch command 520-a may enable separate PCIs to be signaled by a serving cell. For example, separate cell switch commands may be used so that a UE may switch to an indicated downlink or uplink cell. In some cases, the UE 115-c may receive a first cell switch command 520-a indicating to switch to a first candidate target cell for downlink communications, or indicating to switch to the second candidate target cell for uplink communications, or both.

In some examples, a cell switch command 520-a may include an identifier indicating a respective candidate target cell in a field 505-a (e.g., a Target Configuration ID). Additionally, or alternatively, the cell switch command 520-a may include a first bit indicating whether to switch to the respective candidate target cell for downlink communications in a field 505-b, and a second bit indicating whether to switch to the respective candidate target cell for uplink communications in a field 505-c. For example, the field 505-b may be set (e.g., set to a logical value of ‘1’) to indicate to switch to cell having the ID in the field 505-a for downlink communications, or the field 505-c may be set to indicate whether to switch to the cell for uplink communications, or vice versa. Additionally, or alternatively, both bits being set (e.g., to a logical value of ‘1’) may indicate to switch to the cell indicated by the target configuration ID for both uplink and downlink communications. In some cases, the cell switch command 520-a may involve a default value (e.g., default field) for downlink/uplink TCI state ID that involves a same field as another MAC-CE format. Additionally, or alternatively, one of the reserved bits may be set to 0 to indicate that the UE is not to perform a cell switch for uplink or downlink communications.

Additionally, or alternatively, the cell switch command 520-a may include one or more fields operable to indicate either one or more downlink parameters or one or more uplink parameters. For example, a format for the MAC-CE may include uplink parameters or downlink parameters, such as uplink or downlink TCI states. In some cases, two separate MAC-CE formats may include a format for uplink cell switching and a format for downlink cell switching. In such an example, the UE 115-c may receive a separate cell switch command to indicate uplink cells or downlink cells for a given cell switching procedure.

In the example of FIG. 5B, for indicating separate TRPs for downlink and uplink, respectively, the cell switch command 520-b may include two PCIs that a serving cell may signal. For example, the UE 115-c may receive a single cell switch command (e.g., a first cell switch command) indicating the first candidate target cell, the second candidate target cell, or both.

For example, the cell switch command 520-b may include a first identifier associated with downlink communications in a field 505-d and a second identifier associated with uplink communications in a field 505-e (or vice versa). Each identifier may indicate a respective candidate target cell for uplink or downlink. For example, the cell switch command 520-b may be a single cell switch command with 2 PCIs indicated, one for downlink and one for uplink. In some cases, a default rule mapping for the fields 505-d and 505-e may indicate which PCI corresponds to downlink and which PCI corresponds to uplink. In some cases, a target configuration ID 1 may correspond to downlink, and a target configuration ID 2 may correspond to uplink, or vice versa. In some cases, the cell switch commands 520-a and 520-b may indicate one or more TCI states for one or more indicated candidate cells. For example, the cell switch commands 520-a and 520-b may indicate a first TCI state associated with a first candidate target cell for downlink, a second TCI state associated with the second candidate target cell for uplink, or both. In some cases, the upper or lower TCI state in the cell switch command 520-a may apply if the field 505-b or 505-c is set, respectively. In the cell switch command 520-b, the upper TCI state ID may correspond to the target configuration ID 1 of the field 505-d while the lower TCI state ID may apply to the target configuration ID 2 of the field 505-e.

FIG. 6 shows an example of a process flow 600 that supports cell switch command for decoupled downlink and uplink operation in accordance with one or more aspects of the present disclosure. In some examples, the process flow 600 may implement or be implemented by aspects of the wireless communications systems 100 and 300, the network architecture 200, the process flow 400, and the message formats 501 and 502. For example, the process flow 600 may include one or more UEs 115, including a UE 115-d, and one or more network entities 105, including a network entity 105-b (e.g., which may be an example of other network entities described herein, such as a network entity 305), that may support messaging and configurations for combined or separated uplink and downlink communications.

In the following description of the process flow 600, the operations may be performed (such as reported or provided) in a different order than the order shown, or the operations performed by the example devices may be performed in different orders or at different times. Some operations also may be omitted from the process flow 600, or other operations may be added to the process flow 600. Further, although some operations or signaling may be shown to occur at different times for discussion purposes, these operations may actually occur at the same time or at least partially concurrently. In some examples, the network entity 105-b may represent any network entity 105 or 305 described herein, such as a TRP. The network entity 105-b may be implemented in a disaggregated architecture, and may represent, or include, one or more CUs 160, DUs 165, RUs 170, RICs 175, SMO systems 180, or any combination thereof.

In some examples, the process flow 600 may illustrate operations involving a virtual cell including multiple cells sharing a same configuration. For example, an LTM definition may involve defining a virtual cell with a single candidate cell configuration at a DU level, where all TRPs or PCIs within the virtual cell may have a same candidate cell configuration. Additionally, or alternatively, each cell configuration may define separate sub-configurations at a TRP level and identify the sub-configurations with a TRP identifier or a PCI list. For example, at 605, the UE 115-d may receive a control message indicating a configuration for a set of multiple candidate target cells corresponding to the virtual cell, which may include a set of multiple candidate target cells, and each candidate target cell may also be associated with a respective TRP of the virtual cell.

At 615, the UE 115-d may receive a cell switch command (e.g., a cell switch command 320 or 520) that may indicate a first candidate target cell of the set of multiple candidate target cells for use in downlink communications, a second candidate target cell of the set of multiple candidate target cells for use in uplink communications, or both. Further, at 620, the UE 115-d may switch from a first serving cell to the first candidate target cell for downlink communications, from the first serving cell to the second candidate target cell for uplink communications, or both, in response to the received cell switch command. For example, the UE 115-d may switch from a serving cell supporting downlink and uplink communications to a first candidate cell for downlink communications (e.g., a downlink-only cell and TRP of a virtual cell with one configuration) and to a second candidate cell for uplink communications (e.g., an uplink-only cell and TRP of the virtual cell) as described herein with respect to FIGS. 1-3. Additionally, or alternatively, the network entity 105-b may perform operations to switch the UE 115-d between cells, for example, via one or more commands.

In some examples, the cell switch may involve one cell used as a downlink cell and another cell used as an uplink cell after the cell switch. Additionally, or alternatively, there may be one serving cell (e.g., logical serving cell) before the switch, where a physical entity used for downlink and for uplink before the switch may be the same entity or separate entities. The operations described with respect to FIG. 6 may share further similarities with those described with respect to FIG. 4. For example, the UE 115-d may perform one or more measurements at 610 and transmit one or more reports to trigger the cell switch command. The UE 115-d may also receive a second control message at 625 indicating a second configuration for a second set of multiple candidate target cells of which one or more may overlap with the first set based on moving between geographical regions. Further, the cell switch command may indicate a TCI state associated with the first and second candidate target cells, as well as one or more parameters as described in further detail with respect to FIG. 7. Further, in some cases, there may be separate cells (e.g., one for uplink and one for downlink) before the switch.

Utilizing a virtual cell concept may enable backwards compatibility with signaling and devices by reusing a MAC-CE format while using a single cell configuration with one or more added fields. In some cases, a per TRP TCI state pool size may share a total TCI state pool across all TRPs, so that each TRP includes a subset of TCI states. For example, the configuration may include a single TCI state pool associated with the set of multiple candidate target cells to support backwards compatible MAC-CE message formats as further described with respect to FIG. 7. Additionally, or alternatively, the configuration may include a set of multiple TCI state pools each associated with a respective candidate target cell of the set of multiple candidate target cells to reduce overhead in transmissions due to frequent mobility as further described with respect to FIG. 7. Further, in some cases, a network may perform a full RRC reconfiguration during UE mobility each time there is a change in target candidate cells. For example, when one or more TRPs move into or out of a range of coverage of the UE 115-d, the UE may receive a full RRC configuration for the new virtual cell including the new TRPs.

FIG. 7 shows an example of a message format 700 that supports cell switch command for decoupled downlink and uplink operation in accordance with one or more aspects of the present disclosure. In some examples, the message format 700 may implement or be implemented by aspects of the wireless communications systems 100 and 300, the network architecture 200, the process flows 400 and 600, and the message formats 501 and 502. For example, the message format 700 may be a message format for one or more cell switch commands 720 received at the UE 115-d, which may represent one or more cell switch commands 185, 320, or 520 described in FIGS. 1-5B.

In some examples, FIG. 7 may illustrate defining a PCI-1 for a downlink TRP and a PCI-2 for an uplink TRP of a virtual cell. For example, for indicating separate TRPs for downlink and uplink, respectively, a serving cell may signal a cell switch command 720-a may include two PCIs. In some cases, the UE 115-d may receive a single cell switch command (e.g., a first cell switch command) including a first identifier indicating a first candidate target cell, a second identifier indicating a second candidate target cell, or both. For example, the cell switch command 720-a may include one or more fields 705, which may be similar to fields 505 described in FIGS. 5A and 5B. In some examples, the cell switch command 720-a may include a field 705-a and a field 705-b for indicating a target PCI 1 for the first target candidate cell, and a target PCI 2 for the second candidate target cell in place of a configuration ID.

In some cases, a single TCI state pool may be used. For example, a system using a virtual cell and the message format 700 for MAC-CE may implement a single TCI pool state pool across each candidate TRP within a serving cell. In such a scenario, the message format 700 may utilize an existing MAC-CE format, supporting backwards compatibility. In some cases, each TRP may be associated with a subset of a relatively large TCI state pool to increase a quantity of available TCI states, where the TCI subsets may be unique to each TRP and indicated by one or more TCI state IDs included in the command. In some cases, the upper TCI State ID may correspond to the Target PCI 1 of the field 705-a, and the lower TCI State ID may correspond to the Target PCI 2 of the field 705-b. Additionally, or alternatively, a TCI state pool may be TRP specific within a serving cell, where a respective PCI may identify each pool, which may reduce overhead in comparison to additional fields used to indicate a relatively large TCI pool (e.g., in a single shared pool). For example, the cell switch command 720-a may also include one or more identifiers indicating one or more candidate target cells and one or more respective TCI state pools. In some cases, the target PCIs in the fields 705-a and 705-b may indicate respective TCI state pools for each PCI and associated TRP and sub-cell of the virtual cell.

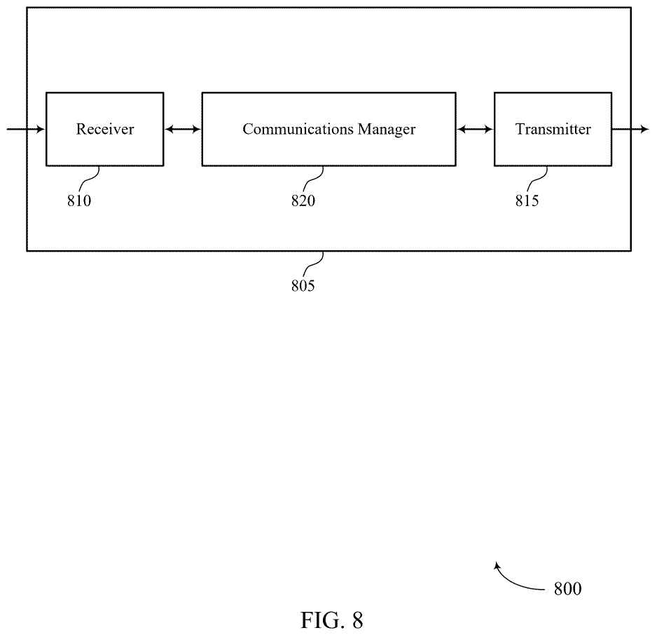

FIG. 8 shows a block diagram 800 of a device 805 that supports cell switch command for decoupled downlink and uplink operation in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to cell switch command for decoupled downlink and uplink operation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to cell switch command for decoupled downlink and uplink operation). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of cell switch command for decoupled downlink and uplink operation as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof (not shown) configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 is capable of, configured to, or operable to support a means for receiving one or more control messages indicating a set of multiple configurations for a set of multiple candidate target cells. The communications manager 820 is capable of, configured to, or operable to support a means for receiving one or more cell switch commands, the one or more cell switch commands indicating a first candidate target cell of the set of multiple candidate target cells for use in downlink communications, a second candidate target cell of the set of multiple candidate target cells for use in uplink communications, or both. The communications manager 820 is capable of, configured to, or operable to support a means for switching from a first serving cell to the first candidate target cell for downlink communications, from the first serving cell to the second candidate target cell for uplink communications, or both, in response to the received one or more cell switch commands.

Additionally, or alternatively, the communications manager 820 may support wireless communication in accordance with examples as disclosed herein. For example, the communications manager 820 is capable of, configured to, or operable to support a means for receiving a control message indicating a configuration for a set of multiple candidate target cells corresponding to a virtual cell including the set of multiple candidate target cells. The communications manager 820 is capable of, configured to, or operable to support a means for receiving a cell switch command, the cell switch command indicating a first candidate target cell of the set of multiple candidate target cells for use in downlink communications, a second candidate target cell of the set of multiple candidate target cells for use in uplink communications, or both. The communications manager 820 is capable of, configured to, or operable to support a means for switching from a first serving cell to the first candidate target cell for downlink communications, from the first serving cell to the second candidate target cell for uplink communications, or both, in response to the received cell switch command.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources by enabling operations, signaling, and configurations for decoupling between uplink and downlink communications.

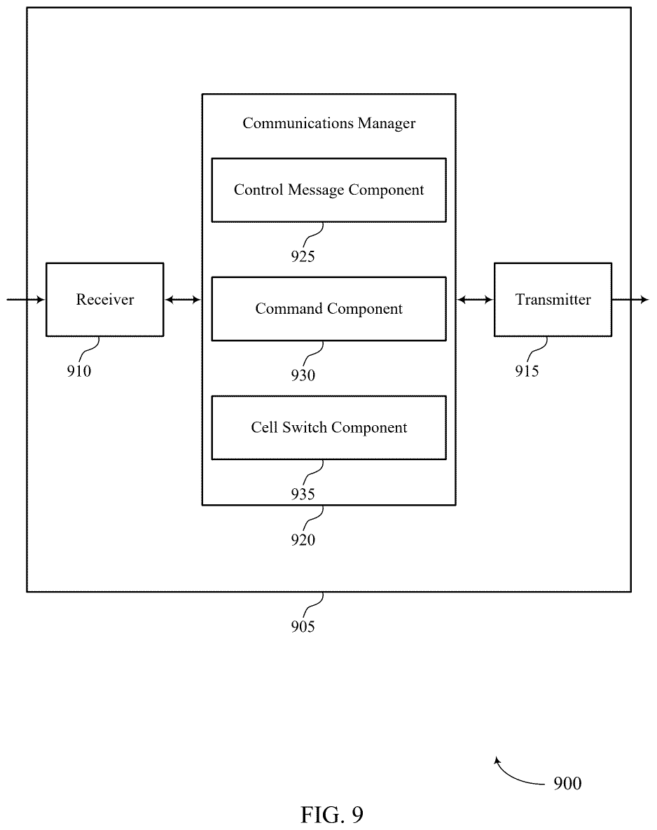

FIG. 9 shows a block diagram 900 of a device 905 that supports cell switch command for decoupled downlink and uplink operation in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to cell switch command for decoupled downlink and uplink operation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to cell switch command for decoupled downlink and uplink operation). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of cell switch command for decoupled downlink and uplink operation as described herein. For example, the communications manager 920 may include a control message component 925, a command component 930, a cell switch component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The control message component 925 is capable of, configured to, or operable to support a means for receiving one or more control messages indicating a set of multiple configurations for a set of multiple candidate target cells. The command component 930 is capable of, configured to, or operable to support a means for receiving one or more cell switch commands, the one or more cell switch commands indicating a first candidate target cell of the set of multiple candidate target cells for use in downlink communications, a second candidate target cell of the set of multiple candidate target cells for use in uplink communications, or both. The cell switch component 935 is capable of, configured to, or operable to support a means for switching from a first serving cell to the first candidate target cell for downlink communications, from the first serving cell to the second candidate target cell for uplink communications, or both, in response to the received one or more cell switch commands.

Additionally, or alternatively, the communications manager 920 may support wireless communication in accordance with examples as disclosed herein. The control message component 925 is capable of, configured to, or operable to support a means for receiving a control message indicating a configuration for a set of multiple candidate target cells corresponding to a virtual cell including the set of multiple candidate target cells. The command component 930 is capable of, configured to, or operable to support a means for receiving a cell switch command, the cell switch command indicating a first candidate target cell of the set of multiple candidate target cells for use in downlink communications, a second candidate target cell of the set of multiple candidate target cells for use in uplink communications, or both. The cell switch component 935 is capable of, configured to, or operable to support a means for switching from a first serving cell to the first candidate target cell for downlink communications, from the first serving cell to the second candidate target cell for uplink communications, or both, in response to the received cell switch command.

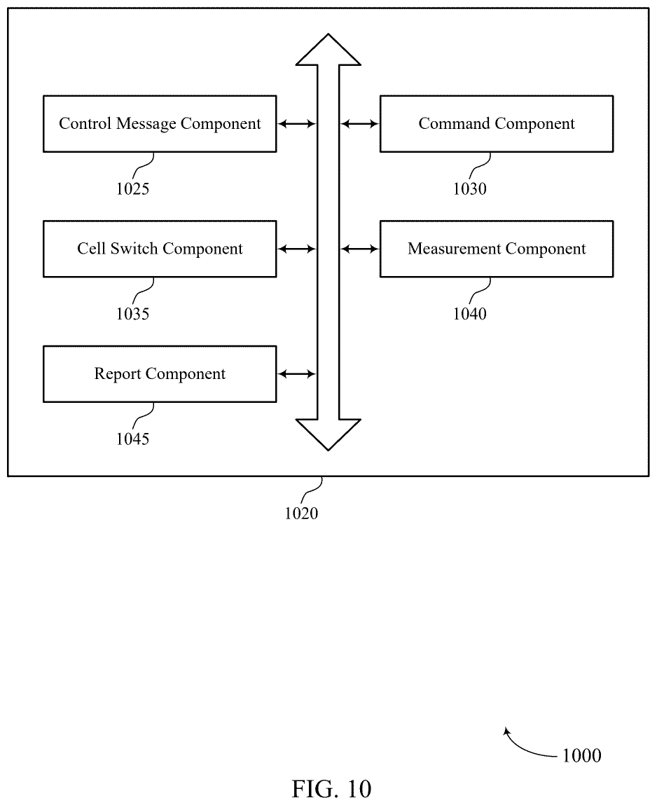

FIG. 10 shows a block diagram 1000 of a communications manager 1020 that supports cell switch command for decoupled downlink and uplink operation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of cell switch command for decoupled downlink and uplink operation as described herein. For example, the communications manager 1020 may include a control message component 1025, a command component 1030, a cell switch component 1035, a measurement component 1040, a report component 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communication in accordance with examples as disclosed herein. The control message component 1025 is capable of, configured to, or operable to support a means for receiving one or more control messages indicating a set of multiple configurations for a set of multiple candidate target cells. The command component 1030 is capable of, configured to, or operable to support a means for receiving one or more cell switch commands, the one or more cell switch commands indicating a first candidate target cell of the set of multiple candidate target cells for use in downlink communications, a second candidate target cell of the set of multiple candidate target cells for use in uplink communications, or both. The cell switch component 1035 is capable of, configured to, or operable to support a means for switching from a first serving cell to the first candidate target cell for downlink communications, from the first serving cell to the second candidate target cell for uplink communications, or both, in response to the received one or more cell switch commands.

In some examples, to support receiving the one or more cell switch commands, the command component 1030 is capable of, configured to, or operable to support a means for receiving a first cell switch command indicating to switch to the first candidate target cell for downlink communications. In some examples, to support receiving the one or more cell switch commands, the command component 1030 is capable of, configured to, or operable to support a means for receiving a second cell switch command indicating to switch to the second candidate target cell for uplink communications; or both.

In some examples, the first cell switch command, the second cell switch command, or both, includes a respective identifier indicating a respective candidate target cell, a first bit indicating whether to switch to the respective candidate target cell for downlink communications, and a second bit indicating whether to switch to the respective candidate target cell for uplink communications.

In some examples, the first cell switch command, the second cell switch command, or both, includes one or more fields operable to indicate either one or more downlink parameters or one or more uplink parameters.

In some examples, to support receiving the one or more cell switch commands, the command component 1030 is capable of, configured to, or operable to support a means for receiving a first cell switch command indicating the first candidate target cell, the second candidate target cell, or both.

In some examples, the first cell switch command includes a first identifier associated with downlink communications and a second identifier associated with uplink communications. In some examples, the first identifier indicates the first candidate target cell, the second identifier indicates the second candidate target cell, or both.

In some examples, the control message component 1025 is capable of, configured to, or operable to support a means for receiving one or more second control messages indicating a second set of multiple configurations for a second set of multiple candidate target cells based on moving from a first geographical region to a second geographical region, where one or more of the set of multiple candidate target cells overlap with one or more of the second set of multiple candidate target cells.

In some examples, the measurement component 1040 is capable of, configured to, or operable to support a means for performing a set of multiple measurements via a set of multiple signals received from the set of multiple candidate target cells. In some examples, the report component 1045 is capable of, configured to, or operable to support a means for transmitting one or more reports indicating the set of multiple measurements, where receiving the one or more cell switch commands is in response to transmitting the one or more reports.

In some examples, the one or more cell switch commands indicate a first TCI state associated with the first candidate target cell, a second TCI state associated with the second candidate target cell, or both.

In some examples, the one or more cell switch commands indicate one or more parameters associated with the first candidate target cell, associated with the second candidate target cell, or both. In some examples, the one or more parameters indicate one or more timing advance values, one or more random access preambles, one or more synchronization signals, one or more random access masks, a quantity of repetitions, or any combination thereof.

In some examples, each candidate target cell of the set of multiple candidate target cells is associated with a respective TRP.

Additionally, or alternatively, the communications manager 1020 may support wireless communication in accordance with examples as disclosed herein. In some examples, the control message component 1025 is capable of, configured to, or operable to support a means for receiving a control message indicating a configuration for a set of multiple candidate target cells corresponding to a virtual cell including the set of multiple candidate target cells. In some examples, the command component 1030 is capable of, configured to, or operable to support a means for receiving a cell switch command, the cell switch command indicating a first candidate target cell of the set of multiple candidate target cells for use in downlink communications, a second candidate target cell of the set of multiple candidate target cells for use in uplink communications, or both. In some examples, the cell switch component 1035 is capable of, configured to, or operable to support a means for switching from a first serving cell to the first candidate target cell for downlink communications, from the first serving cell to the second candidate target cell for uplink communications, or both, in response to the received cell switch command.

In some examples, to support receiving the cell switch command, the command component 1030 is capable of, configured to, or operable to support a means for receiving a first cell switch command including a first identifier indicating the first candidate target cell, a second identifier indicating the second candidate target cell, or both.

In some examples, the configuration includes a single TCI state pool associated with the set of multiple candidate target cells.

In some examples, the configuration includes a set of multiple TCI state pools each associated with a respective candidate target cell of the set of multiple candidate target cells. In some examples, the cell switch command includes one or more identifiers indicating one or more candidate target cells and one or more respective TCI state pools.

In some examples, the control message component 1025 is capable of, configured to, or operable to support a means for receiving a second control message indicating a second configuration for a second set of multiple candidate target cells based on moving from a first geographical region to a second geographical region, where one or more of the set of multiple candidate target cells overlap with one or more of the second set of multiple candidate target cells.

In some examples, the measurement component 1040 is capable of, configured to, or operable to support a means for performing a set of multiple measurements via a set of multiple signals received from the set of multiple candidate target cells. In some examples, the report component 1045 is capable of, configured to, or operable to support a means for transmitting one or more reports indicating the set of multiple measurements, where receiving the cell switch command is in response to transmitting the one or more reports.

In some examples, the cell switch command indicates a first TCI state associated with the first candidate target cell, a second TCI state associated with the second candidate target cell, or both.

In some examples, the cell switch command indicates one or more parameters associated with the first candidate target cell, associated with the second candidate target cell, or both. In some examples, the one or more parameters indicate one or more timing advance values, one or more random access preambles, one or more synchronization signals, one or more random access masks, a quantity of repetitions, or any combination thereof.

In some examples, each candidate target cell of the set of multiple candidate target cells is associated with a respective TRP of the virtual cell.

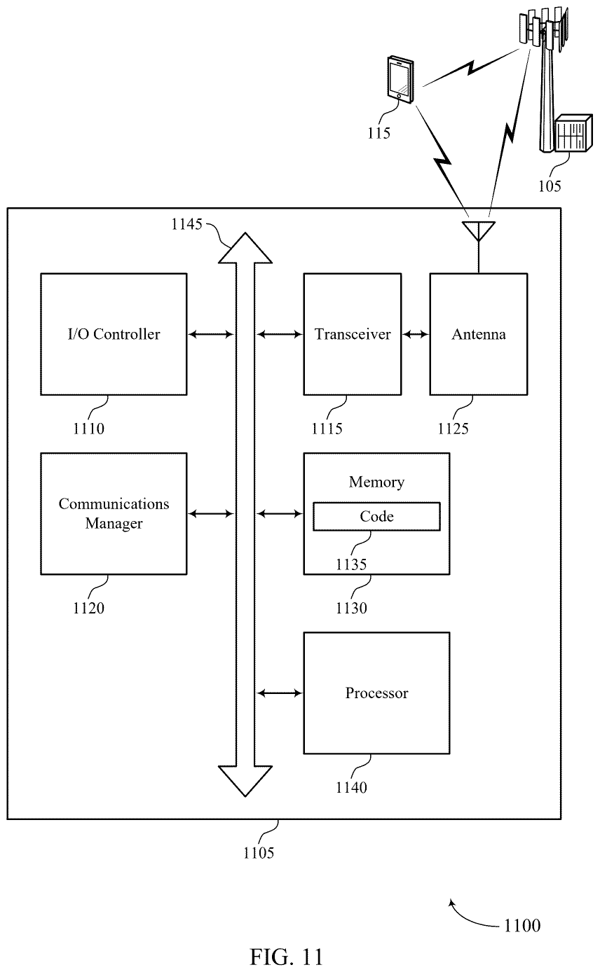

FIG. 11 shows a diagram of a system 1100 including a device 1105 that supports cell switch command for decoupled downlink and uplink operation in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting cell switch command for decoupled downlink and uplink operation). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communication in accordance with examples as disclosed herein. For example, the communications manager 1120 is capable of, configured to, or operable to support a means for receiving one or more control messages indicating a set of multiple configurations for a set of multiple candidate target cells. The communications manager 1120 is capable of, configured to, or operable to support a means for receiving one or more cell switch commands, the one or more cell switch commands indicating a first candidate target cell of the set of multiple candidate target cells for use in downlink communications, a second candidate target cell of the set of multiple candidate target cells for use in uplink communications, or both. The communications manager 1120 is capable of, configured to, or operable to support a means for switching from a first serving cell to the first candidate target cell for downlink communications, from the first serving cell to the second candidate target cell for uplink communications, or both, in response to the received one or more cell switch commands.

Additionally, or alternatively, the communications manager 1120 may support wireless communication in accordance with examples as disclosed herein. For example, the communications manager 1120 is capable of, configured to, or operable to support a means for receiving a control message indicating a configuration for a set of multiple candidate target cells corresponding to a virtual cell including the set of multiple candidate target cells. The communications manager 1120 is capable of, configured to, or operable to support a means for receiving a cell switch command, the cell switch command indicating a first candidate target cell of the set of multiple candidate target cells for use in downlink communications, a second candidate target cell of the set of multiple candidate target cells for use in uplink communications, or both. The communications manager 1120 is capable of, configured to, or operable to support a means for switching from a first serving cell to the first candidate target cell for downlink communications, from the first serving cell to the second candidate target cell for uplink communications, or both, in response to the received cell switch command.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, and longer battery life by enabling operations, signaling, and configurations for decoupling between uplink and downlink communications.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of cell switch command for decoupled downlink and uplink operation as described herein, or the at least one processor 1140 and the at least one memory 1130 may be otherwise configured to, individually or collectively, perform or support such operations.

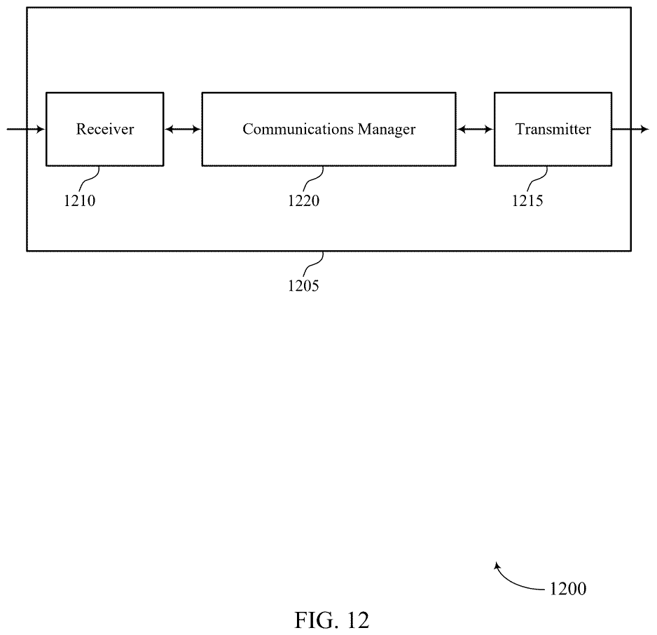

FIG. 12 shows a block diagram 1200 of a device 1205 that supports cell switch command for decoupled downlink and uplink operation in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of cell switch command for decoupled downlink and uplink operation as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof (not shown) configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. For example, the communications manager 1220 is capable of, configured to, or operable to support a means for outputting one or more control messages indicating a set of multiple configurations for a set of multiple candidate target cells. The communications manager 1220 is capable of, configured to, or operable to support a means for outputting one or more cell switch commands, the one or more cell switch commands indicating a first candidate target cell of the set of multiple candidate target cells for use in downlink communications, a second candidate target cell of the set of multiple candidate target cells for use in uplink communications, or both.

Additionally, or alternatively, the communications manager 1220 may support wireless communication in accordance with examples as disclosed herein. For example, the communications manager 1220 is capable of, configured to, or operable to support a means for outputting a control message indicating a configuration for a set of multiple candidate target cells corresponding to a virtual cell including the set of multiple candidate target cells. The communications manager 1220 is capable of, configured to, or operable to support a means for outputting a cell switch command, the cell switch command indicating a first candidate target cell of the set of multiple candidate target cells for use in downlink communications, a second candidate target cell of the set of multiple candidate target cells for use in uplink communications, or both.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, and more efficient utilization of communication resources by enabling operations, signaling, and configurations for decoupling between uplink and downlink communications.

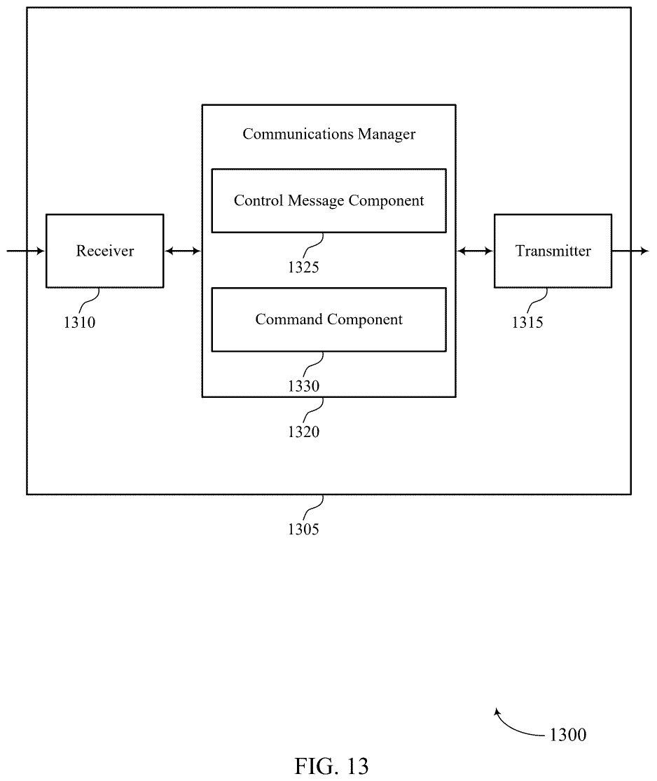

FIG. 13 shows a block diagram 1300 of a device 1305 that supports cell switch command for decoupled downlink and uplink operation in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of cell switch command for decoupled downlink and uplink operation as described herein. For example, the communications manager 1320 may include a control message component 1325 a command component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication in accordance with examples as disclosed herein. The control message component 1325 is capable of, configured to, or operable to support a means for outputting one or more control messages indicating a set of multiple configurations for a set of multiple candidate target cells. The command component 1330 is capable of, configured to, or operable to support a means for outputting one or more cell switch commands, the one or more cell switch commands indicating a first candidate target cell of the set of multiple candidate target cells for use in downlink communications, a second candidate target cell of the set of multiple candidate target cells for use in uplink communications, or both.

Additionally, or alternatively, the communications manager 1320 may support wireless communication in accordance with examples as disclosed herein. The control message component 1325 is capable of, configured to, or operable to support a means for outputting a control message indicating a configuration for a set of multiple candidate target cells corresponding to a virtual cell including the set of multiple candidate target cells. The command component 1330 is capable of, configured to, or operable to support a means for outputting a cell switch command, the cell switch command indicating a first candidate target cell of the set of multiple candidate target cells for use in downlink communications, a second candidate target cell of the set of multiple candidate target cells for use in uplink communications, or both.

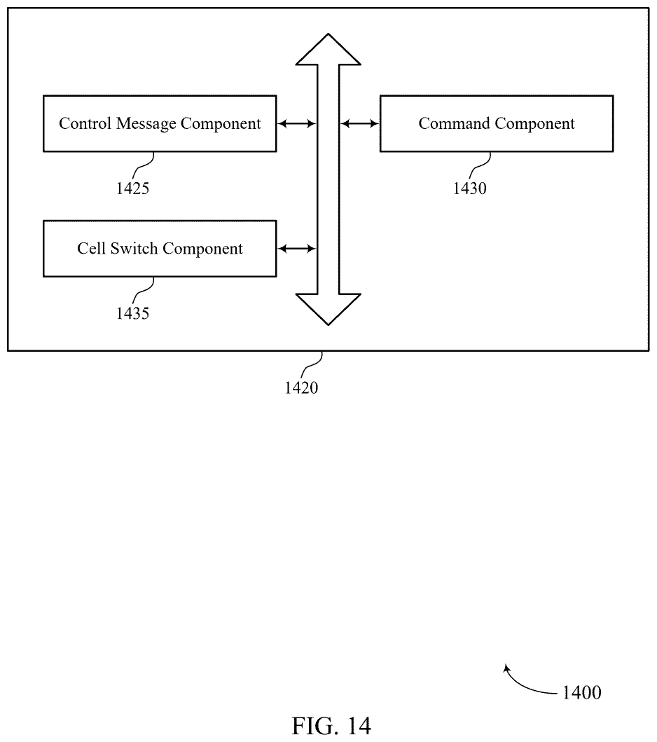

FIG. 14 shows a block diagram 1400 of a communications manager 1420 that supports cell switch command for decoupled downlink and uplink operation in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of cell switch command for decoupled downlink and uplink operation as described herein. For example, the communications manager 1420 may include a control message component 1425, a command component 1430, a cell switch component 1435, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication in accordance with examples as disclosed herein. The control message component 1425 is capable of, configured to, or operable to support a means for outputting one or more control messages indicating a set of multiple configurations for a set of multiple candidate target cells. The command component 1430 is capable of, configured to, or operable to support a means for outputting one or more cell switch commands, the one or more cell switch commands indicating a first candidate target cell of the set of multiple candidate target cells for use in downlink communications, a second candidate target cell of the set of multiple candidate target cells for use in uplink communications, or both.

In some examples, to support outputting the one or more cell switch commands, the command component 1430 is capable of, configured to, or operable to support a means for outputting a first cell switch command indicating to switch to the first candidate target cell for downlink communications. In some examples, to support outputting the one or more cell switch commands, the command component 1430 is capable of, configured to, or operable to support a means for outputting a second cell switch command indicating to switch to the second candidate target cell for uplink communications; or both.

In some examples, the first cell switch command, the second cell switch command, or both, includes a respective identifier indicating a respective candidate target cell, a first bit indicating whether to switch to the respective candidate target cell for downlink communications, and a second bit indicating whether to switch to the respective candidate target cell for uplink communications.

In some examples, the first cell switch command, the second cell switch command, or both, includes one or more fields operable to indicate either one or more downlink parameters or one or more uplink parameters.

In some examples, to support outputting the one or more cell switch commands, the command component 1430 is capable of, configured to, or operable to support a means for outputting a first cell switch command indicating the first candidate target cell, the second candidate target cell, or both.

In some examples, the cell switch component 1435 is capable of, configured to, or operable to support a means for switching a first UE from a first serving cell to the first candidate target cell for downlink communications, from the first serving cell to the second candidate target cell for uplink communications, or both, in response to outputting the one or more cell switch commands.

Additionally, or alternatively, the communications manager 1420 may support wireless communication in accordance with examples as disclosed herein. In some examples, the control message component 1425 is capable of, configured to, or operable to support a means for outputting a control message indicating a configuration for a set of multiple candidate target cells corresponding to a virtual cell including the set of multiple candidate target cells. In some examples, the command component 1430 is capable of, configured to, or operable to support a means for outputting a cell switch command, the cell switch command indicating a first candidate target cell of the set of multiple candidate target cells for use in downlink communications, a second candidate target cell of the set of multiple candidate target cells for use in uplink communications, or both.

In some examples, to support outputting the cell switch command, the command component 1430 is capable of, configured to, or operable to support a means for outputting a first cell switch command including a first identifier indicating the first candidate target cell, a second identifier indicating the second candidate target cell, or both.

In some examples, the configuration includes a single TCI state pool associated with the set of multiple candidate target cells. In some examples, the configuration includes a set of multiple TCI state pools each associated with a respective candidate target cell of the set of multiple candidate target cells. In some examples, the cell switch command includes one or more identifiers indicating one or more candidate target cells and one or more respective TCI state pools.

In some examples, the cell switch component 1435 is capable of, configured to, or operable to support a means for switching a first UE from a first serving cell to the first candidate target cell for downlink communications, from the first serving cell to the second candidate target cell for uplink communications, or both, in response to outputting the cell switch command.

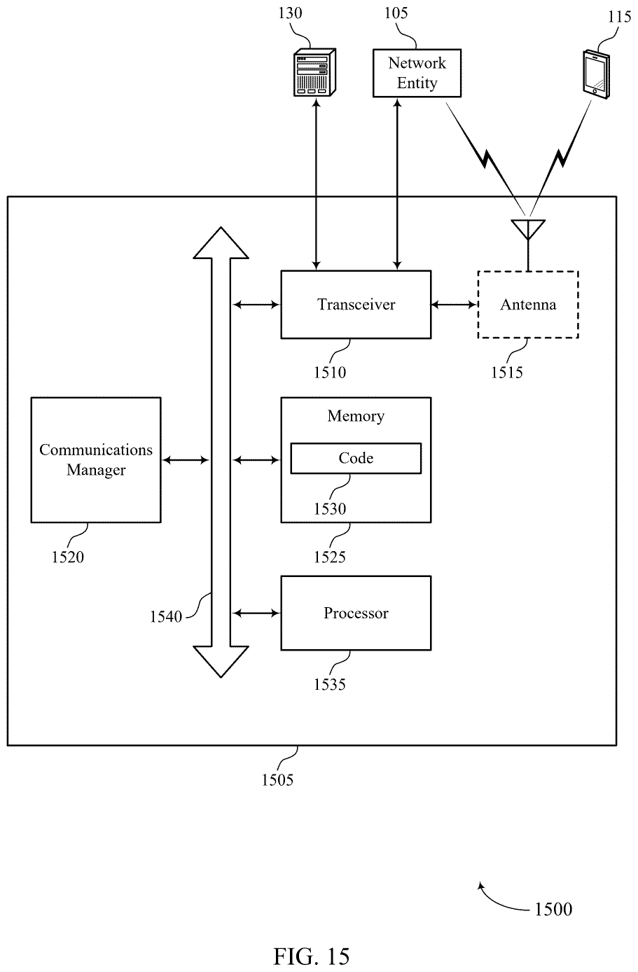

FIG. 15 shows a diagram of a system 1500 including a device 1505 that supports cell switch command for decoupled downlink and uplink operation in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting cell switch command for decoupled downlink and uplink operation). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communication in accordance with examples as disclosed herein. For example, the communications manager 1520 is capable of, configured to, or operable to support a means for outputting one or more control messages indicating a set of multiple configurations for a set of multiple candidate target cells. The communications manager 1520 is capable of, configured to, or operable to support a means for outputting one or more cell switch commands, the one or more cell switch commands indicating a first candidate target cell of the set of multiple candidate target cells for use in downlink communications, a second candidate target cell of the set of multiple candidate target cells for use in uplink communications, or both.

Additionally, or alternatively, the communications manager 1520 may support wireless communication in accordance with examples as disclosed herein. For example, the communications manager 1520 is capable of, configured to, or operable to support a means for outputting a control message indicating a configuration for a set of multiple candidate target cells corresponding to a virtual cell including the set of multiple candidate target cells. The communications manager 1520 is capable of, configured to, or operable to support a means for outputting a cell switch command, the cell switch command indicating a first candidate target cell of the set of multiple candidate target cells for use in downlink communications, a second candidate target cell of the set of multiple candidate target cells for use in uplink communications, or both.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, and longer battery life by enabling operations, signaling, and configurations for decoupling between uplink and downlink communications.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of cell switch command for decoupled downlink and uplink operation as described herein, or the at least one processor 1535 and the at least one memory 1525 may be otherwise configured to, individually or collectively, perform or support such operations.

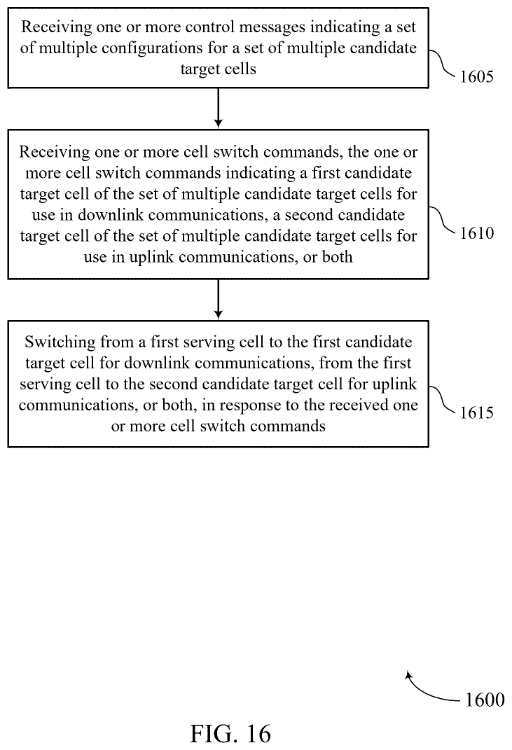

FIG. 16 shows a flowchart illustrating a method 1600 that supports cell switch command for decoupled downlink and uplink operation in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving one or more control messages indicating a set of multiple configurations for a set of multiple candidate target cells. The operations of 1605 may be performed in accordance with examples as disclosed herein. In some examples, aspects of the operations of 1605 may be performed by a control message component 1025 as described with reference to FIG. 10.

At 1610, the method may include receiving one or more cell switch commands, the one or more cell switch commands indicating a first candidate target cell of the set of multiple candidate target cells for use in downlink communications, a second candidate target cell of the set of multiple candidate target cells for use in uplink communications, or both. The operations of 1610 may be performed in accordance with examples as disclosed herein. In some examples, aspects of the operations of 1610 may be performed by a command component 1030 as described with reference to FIG. 10.

At 1615, the method may include switching from a first serving cell to the first candidate target cell for downlink communications, from the first serving cell to the second candidate target cell for uplink communications, or both, in response to the received one or more cell switch commands. The operations of 1615 may be performed in accordance with examples as disclosed herein. In some examples, aspects of the operations of 1615 may be performed by a cell switch component 1035 as described with reference to FIG. 10.

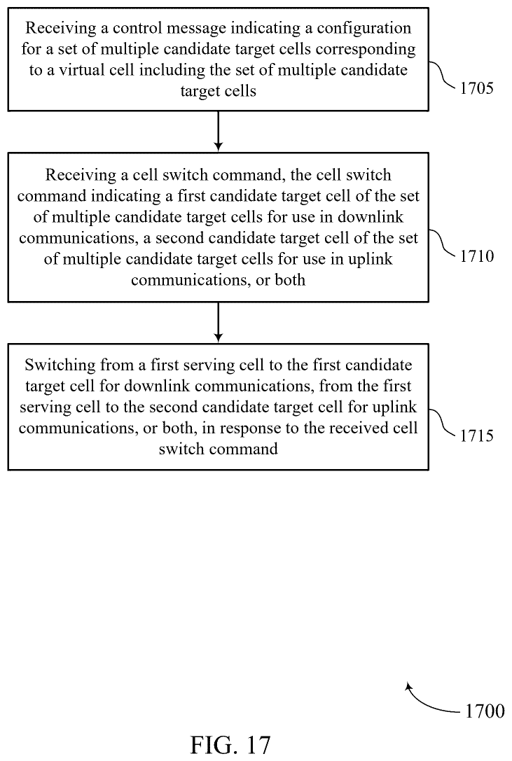

FIG. 17 shows a flowchart illustrating a method 1700 that supports cell switch command for decoupled downlink and uplink operation in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving a control message indicating a configuration for a set of multiple candidate target cells corresponding to a virtual cell including the set of multiple candidate target cells. The operations of 1705 may be performed in accordance with examples as disclosed herein. In some examples, aspects of the operations of 1705 may be performed by a control message component 1025 as described with reference to FIG. 10.

At 1710, the method may include receiving a cell switch command, the cell switch command indicating a first candidate target cell of the set of multiple candidate target cells for use in downlink communications, a second candidate target cell of the set of multiple candidate target cells for use in uplink communications, or both. The operations of 1710 may be performed in accordance with examples as disclosed herein. In some examples, aspects of the operations of 1710 may be performed by a command component 1030 as described with reference to FIG. 10.

At 1715, the method may include switching from a first serving cell to the first candidate target cell for downlink communications, from the first serving cell to the second candidate target cell for uplink communications, or both, in response to the received cell switch command. The operations of 1715 may be performed in accordance with examples as disclosed herein. In some examples, aspects of the operations of 1715 may be performed by a cell switch component 1035 as described with reference to FIG. 10.

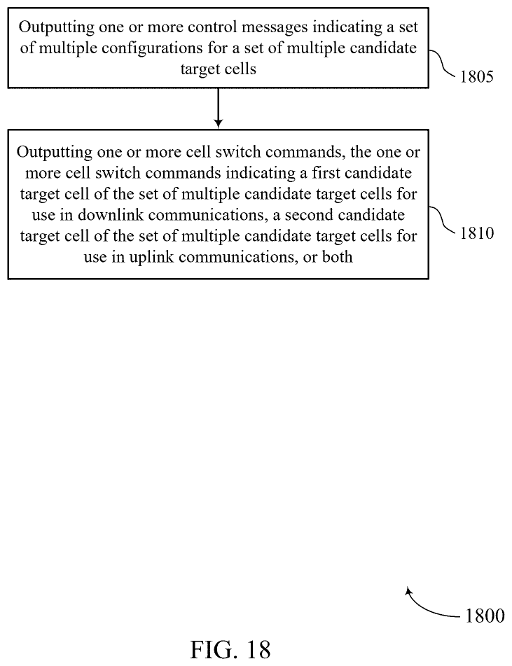

FIG. 18 shows a flowchart illustrating a method 1800 that supports cell switch command for decoupled downlink and uplink operation in accordance with one or more aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include outputting one or more control messages indicating a set of multiple configurations for a set of multiple candidate target cells. The operations of 1805 may be performed in accordance with examples as disclosed herein. In some examples, aspects of the operations of 1805 may be performed by a control message component 1425 as described with reference to FIG. 14.

At 1810, the method may include outputting one or more cell switch commands, the one or more cell switch commands indicating a first candidate target cell of the set of multiple candidate target cells for use in downlink communications, a second candidate target cell of the set of multiple candidate target cells for use in uplink communications, or both. The operations of 1810 may be performed in accordance with examples as disclosed herein. In some examples, aspects of the operations of 1810 may be performed by a command component 1430 as described with reference to FIG. 14.

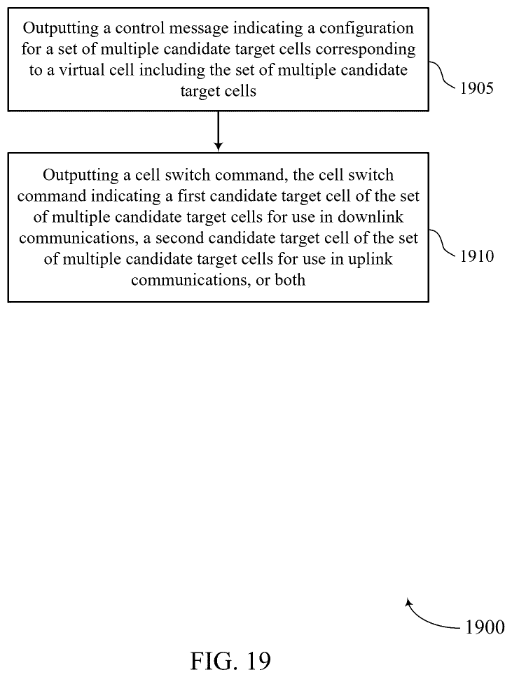

FIG. 19 shows a flowchart illustrating a method 1900 that supports cell switch command for decoupled downlink and uplink operation in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include outputting a control message indicating a configuration for a set of multiple candidate target cells corresponding to a virtual cell including the set of multiple candidate target cells. The operations of 1905 may be performed in accordance with examples as disclosed herein. In some examples, aspects of the operations of 1905 may be performed by a control message component 1425 as described with reference to FIG. 14.

At 1910, the method may include outputting a cell switch command, the cell switch command indicating a first candidate target cell of the set of multiple candidate target cells for use in downlink communications, a second candidate target cell of the set of multiple candidate target cells for use in uplink communications, or both. The operations of 1910 may be performed in accordance with examples as disclosed herein. In some examples, aspects of the operations of 1910 may be performed by a command component 1430 as described with reference to FIG. 14.

The following provides an overview of aspects of the present disclosure:
Aspect 1: A method for wireless communication by a UE, comprising: receiving one or more control messages indicating a plurality of configurations for a plurality of candidate target cells; receiving one or more cell switch commands, the one or more cell switch commands indicating a first candidate target cell of the plurality of candidate target cells for use in downlink communications, a second candidate target cell of the plurality of candidate target cells for use in uplink communications, or both; and switching from a first serving cell to the first candidate target cell for downlink communications, from the first serving cell to the second candidate target cell for uplink communications, or both, in response to the received one or more cell switch commands.
Aspect 2: The method of aspect 1, wherein receiving the one or more cell switch commands comprises: receiving a first cell switch command indicating to switch to the first candidate target cell for downlink communications; or receiving a second cell switch command indicating to switch to the second candidate target cell for uplink communications; or both.
Aspect 3: The method of aspect 2, wherein the first cell switch command, the second cell switch command, or both, comprises a respective identifier indicating a respective candidate target cell, a first bit indicating whether to switch to the respective candidate target cell for downlink communications, and a second bit indicating whether to switch to the respective candidate target cell for uplink communications.
Aspect 4: The method of any of aspects 2 through 3, wherein the first cell switch command, the second cell switch command, or both, comprises one or more fields operable to indicate either one or more downlink parameters or one or more uplink parameters.
Aspect 5: The method of any of aspects 1 through 4, wherein receiving the one or more cell switch commands comprises: receiving a first cell switch command indicating the first candidate target cell, the second candidate target cell, or both.
Aspect 6: The method of aspect 5, wherein the first cell switch command comprises a first identifier associated with downlink communications and a second identifier associated with uplink communications, and the first identifier indicates the first candidate target cell, the second identifier indicates the second candidate target cell, or both.
Aspect 7: The method of any of aspects 1 through 6, further comprising: receiving one or more second control messages indicating a second plurality of configurations for a second plurality of candidate target cells based at least in part on moving from a first geographical region to a second geographical region, wherein one or more of the plurality of candidate target cells overlap with one or more of the second plurality of candidate target cells.
Aspect 8: The method of any of aspects 1 through 7, further comprising: performing a plurality of measurements via a plurality of signals received from the plurality of candidate target cells; and transmitting one or more reports indicating the plurality of measurements, wherein receiving the one or more cell switch commands is in response to transmitting the one or more reports.
Aspect 9: The method of any of aspects 1 through 8, wherein the one or more cell switch commands indicate a first TCI state associated with the first candidate target cell, a second TCI state associated with the second candidate target cell, or both.
Aspect 10: The method of any of aspects 1 through 9, wherein the one or more cell switch commands indicate one or more parameters associated with the first candidate target cell, associated with the second candidate target cell, or both, and the one or more parameters indicate one or more timing advance values, one or more random access preambles, one or more synchronization signals, one or more random access masks, a quantity of repetitions, or any combination thereof.
Aspect 11: The method of any of aspects 1 through 10, wherein each candidate target cell of the plurality of candidate target cells is associated with a respective TRP.
Aspect 12: A method for wireless communication by a UE, comprising: receiving a control message indicating a configuration for a plurality of candidate target cells corresponding to a virtual cell comprising the plurality of candidate target cells; receiving a cell switch command, the cell switch command indicating a first candidate target cell of the plurality of candidate target cells for use in downlink communications, a second candidate target cell of the plurality of candidate target cells for use in uplink communications, or both; and switching from a first serving cell to the first candidate target cell for downlink communications, from the first serving cell to the second candidate target cell for uplink communications, or both, in response to the received cell switch command.
Aspect 13: The method of aspect 12, wherein receiving the cell switch command comprises: receiving a first cell switch command comprising a first identifier indicating the first candidate target cell, a second identifier indicating the second candidate target cell, or both.
Aspect 14: The method of any of aspects 12 through 13, wherein the configuration comprises a single TCI state pool associated with the plurality of candidate target cells.
Aspect 15: The method of any of aspects 12 through 14, wherein the configuration comprises a plurality of TCI state pools each associated with a respective candidate target cell of the plurality of candidate target cells, and the cell switch command comprises one or more identifiers indicating one or more candidate target cells and one or more respective TCI state pools.
Aspect 16: The method of any of aspects 12 through 15, further comprising: receiving a second control message indicating a second configuration for a second plurality of candidate target cells based at least in part on moving from a first geographical region to a second geographical region, wherein one or more of the plurality of candidate target cells overlap with one or more of the second plurality of candidate target cells.
Aspect 17: The method of any of aspects 12 through 16, further comprising: performing a plurality of measurements via a plurality of signals received from the plurality of candidate target cells; and transmitting one or more reports indicating the plurality of measurements, wherein receiving the cell switch command is in response to transmitting the one or more reports.
Aspect 18: The method of any of aspects 12 through 17, wherein the cell switch command indicates a first TCI state associated with the first candidate target cell, a second TCI state associated with the second candidate target cell, or both.
Aspect 19: The method of any of aspects 12 through 18, wherein the cell switch command indicates one or more parameters associated with the first candidate target cell, associated with the second candidate target cell, or both, and the one or more parameters indicate one or more timing advance values, one or more random access preambles, one or more synchronization signals, one or more random access masks, a quantity of repetitions, or any combination thereof.
Aspect 20: The method of any of aspects 12 through 19, wherein each candidate target cell of the plurality of candidate target cells is associated with a respective TRP of the virtual cell.
Aspect 21: A method for wireless communication by a network entity, comprising: outputting one or more control messages indicating at least one configuration of a plurality of configurations for a plurality of candidate target cells; and outputting one or more cell switch commands, the one or more cell switch commands indicating a first candidate target cell of the plurality of candidate target cells for use in downlink communications, a second candidate target cell of the plurality of candidate target cells for use in uplink communications, or both.
Aspect 22: The method of aspect 21, wherein outputting the one or more cell switch commands comprises: outputting a first cell switch command indicating to switch to the first candidate target cell for downlink communications; or outputting a second cell switch command indicating to switch to the second candidate target cell for uplink communications; or both.
Aspect 23: The method of aspect 22, wherein the first cell switch command, the second cell switch command, or both, comprises a respective identifier indicating a respective candidate target cell, a first bit indicating whether to switch to the respective candidate target cell for downlink communications, and a second bit indicating whether to switch to the respective candidate target cell for uplink communications.
Aspect 24: The method of any of aspects 22 through 23, wherein the first cell switch command, the second cell switch command, or both, comprises one or more fields operable to indicate either one or more downlink parameters or one or more uplink parameters.
Aspect 25: The method of any of aspects 21 through 24, wherein outputting the one or more cell switch commands comprises: outputting a first cell switch command indicating the first candidate target cell, the second candidate target cell, or both.
Aspect 26: The method of any of aspects 21 through 25, further comprising: switching a first UE from a first serving cell to the first candidate target cell for downlink communications, from the first serving cell to the second candidate target cell for uplink communications, or both, in response to outputting the one or more cell switch commands.
Aspect 27: A method for wireless communication by a network entity, comprising: outputting a control message indicating a configuration for a plurality of candidate target cells corresponding to a virtual cell comprising the plurality of candidate target cells; and outputting a cell switch command, the cell switch command indicating a first candidate target cell of the plurality of candidate target cells for use in downlink communications, a second candidate target cell of the plurality of candidate target cells for use in uplink communications, or both.
Aspect 28: The method of aspect 27, wherein outputting the cell switch command comprises: outputting a first cell switch command comprising a first identifier indicating the first candidate target cell, a second identifier indicating the second candidate target cell, or both.
Aspect 29: The method of any of aspects 27 through 28, wherein the configuration comprises a single TCI state pool associated with the plurality of candidate target cells, or the configuration comprises a plurality of TCI state pools each associated with a respective candidate target cell of the plurality of candidate target cells, wherein the cell switch command comprises one or more identifiers indicating one or more candidate target cells and one or more respective TCI state pools.
Aspect 30: The method of any of aspects 27 through 29, further comprising: switching a first UE from a first serving cell to the first candidate target cell for downlink communications, from the first serving cell to the second candidate target cell for uplink communications, or both, in response to outputting the cell switch command.
Aspect 31: A UE for wireless communication, comprising one or more memories storing processor-executable code, and one or more processors coupled with the one or more memories and individually or collectively operable to execute the code to cause the UE to perform a method of any of aspects 1 through 11.
Aspect 32: A UE for wireless communication, comprising at least one means for performing a method of any of aspects 1 through 11.
Aspect 33: A non-transitory computer-readable medium storing code for wireless communication, the code comprising instructions executable by one or more processors to perform a method of any of aspects 1 through 11.
Aspect 34: A UE for wireless communication, comprising one or more memories storing processor-executable code, and one or more processors coupled with the one or more memories and individually or collectively operable to execute the code to cause the UE to perform a method of any of aspects 12 through 20.
Aspect 35: A UE for wireless communication, comprising at least one means for performing a method of any of aspects 12 through 20.
Aspect 36: A non-transitory computer-readable medium storing code for wireless communication, the code comprising instructions executable by one or more processors to perform a method of any of aspects 12 through 20.
Aspect 37: A network entity for wireless communication, comprising one or more memories storing processor-executable code, and one or more processors coupled with the one or more memories and individually or collectively operable to execute the code to cause the network entity to perform a method of any of aspects 21 through 26.
Aspect 38: A network entity for wireless communication, comprising at least one means for performing a method of any of aspects 21 through 26.
Aspect 39: A non-transitory computer-readable medium storing code for wireless communication, the code comprising instructions executable by one or more processors to perform a method of any of aspects 21 through 26.
Aspect 40: A network entity for wireless communication, comprising one or more memories storing processor-executable code, and one or more processors coupled with the one or more memories and individually or collectively operable to execute the code to cause the network entity to perform a method of any of aspects 27 through 30.
Aspect 41: A network entity for wireless communication, comprising at least one means for performing a method of any of aspects 27 through 30.
Aspect 42: A non-transitory computer-readable medium storing code for wireless communication, the code comprising instructions executable by one or more processors to perform a method of any of aspects 27 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one processor; and
at least one memory coupled with the at least one processor, with instructions stored in the at least one memory, the instructions being executable by the at least one processor, individually or in any combination, to cause the UE to:
receive one or more control messages indicating a plurality of configurations for a plurality of candidate target cells;
receive one or more cell switch commands, the one or more cell switch commands indicating a first candidate target cell of the plurality of candidate target cells for use in downlink communications, a second candidate target cell of the plurality of candidate target cells for use in uplink communications, or both; and
switch from a first serving cell to the first candidate target cell for downlink communications, from the first serving cell to the second candidate target cell for uplink communications, or both, in response to the received one or more cell switch commands.

2. The UE of claim 1, wherein, to receive the one or more cell switch commands, the instructions are executable by the at least one processor, individually or in any combination, to cause the UE to:
receive a first cell switch command indicating to switch to the first candidate target cell for downlink communications; or
receive a second cell switch command indicating to switch to the second candidate target cell for uplink communications; or both.

3. The UE of claim 2, wherein the first cell switch command, the second cell switch command, or both, comprises a respective identifier indicating a respective candidate target cell, a first bit indicating whether to switch to the respective candidate target cell for downlink communications, and a second bit indicating whether to switch to the respective candidate target cell for uplink communications.

4. The UE of claim 2, wherein the first cell switch command, the second cell switch command, or both, comprises one or more fields operable to indicate either one or more downlink parameters or one or more uplink parameters.

5. The UE of claim 1, wherein, to receive the one or more cell switch commands, the instructions are executable by the at least one processor, individually or in any combination, to cause the UE to:
receive a first cell switch command indicating the first candidate target cell, the second candidate target cell, or both.

6. The UE of claim 5, wherein:
the first cell switch command comprises a first identifier associated with downlink communications and a second identifier associated with uplink communications, and
the first identifier indicates the first candidate target cell, the second identifier indicates the second candidate target cell, or both.

7. The UE of claim 1, wherein the instructions are further executable by the at least one processor, individually or in any combination, to cause the UE to:
receive one or more second control messages indicating a second plurality of configurations for a second plurality of candidate target cells based at least in part on moving from a first geographical region to a second geographical region, wherein one or more of the plurality of candidate target cells overlap with one or more of the second plurality of candidate target cells.

8. The UE of claim 1, wherein the instructions are further executable by the at least one processor, individually or in any combination, to cause the UE to:
perform a plurality of measurements via a plurality of signals received from the plurality of candidate target cells; and
transmit one or more reports indicating the plurality of measurements, wherein receiving the one or more cell switch commands is in response to transmitting the one or more reports.

9. The UE of claim 1, wherein the one or more cell switch commands indicate a first transmission configuration indicator (TCI) state associated with the first candidate target cell, a second TCI state associated with the second candidate target cell, or both.

10. The UE of claim 1, wherein:
the one or more cell switch commands indicate one or more parameters associated with the first candidate target cell, associated with the second candidate target cell, or both, and
the one or more parameters indicate one or more timing advance values, one or more random access preambles, one or more synchronization signals, one or more random access masks, a quantity of repetitions, or any combination thereof.

11. The UE of claim 1, wherein each candidate target cell of the plurality of candidate target cells is associated with a respective transmit-receive point (TRP).

12. A user equipment (UE), comprising:
at least one processor; and
at least one memory coupled with the at least one processor, with instructions stored in the at least one memory, the instructions being executable by the at least one processor, individually or in any combination, to cause the UE to:
receive a control message indicating a configuration for a plurality of candidate target cells corresponding to a virtual cell comprising the plurality of candidate target cells;
receive a cell switch command, the cell switch command indicating a first candidate target cell of the plurality of candidate target cells for use in downlink communications, a second candidate target cell of the plurality of candidate target cells for use in uplink communications, or both; and
switch from a first serving cell to the first candidate target cell for downlink communications, from the first serving cell to the second candidate target cell for uplink communications, or both, in response to the received cell switch command.

13. The UE of claim 12, wherein, to receive the cell switch command, the instructions are executable by the at least one processor, individually or in any combination, to cause the UE to:
receive a first cell switch command comprising a first identifier indicating the first candidate target cell, a second identifier indicating the second candidate target cell, or both.

14. The UE of claim 12, wherein the configuration comprises a single transmission configuration indicator (TCI) state pool associated with the plurality of candidate target cells.

15. The UE of claim 12, wherein:
the configuration comprises a plurality of transmission configuration indicator (TCI) state pools each associated with a respective candidate target cell of the plurality of candidate target cells, and
the cell switch command comprises one or more identifiers indicating one or more candidate target cells and one or more respective TCI state pools.

16. The UE of claim 12, wherein the instructions are further executable by the at least one processor, individually or in any combination, to cause the UE to:
receive a second control message indicating a second configuration for a second plurality of candidate target cells based at least in part on moving from a first geographical region to a second geographical region, wherein one or more of the plurality of candidate target cells overlap with one or more of the second plurality of candidate target cells.

17. The UE of claim 12, wherein the instructions are further executable by the at least one processor, individually or in any combination, to cause the UE to:
perform a plurality of measurements via a plurality of signals received from the plurality of candidate target cells; and
transmit one or more reports indicating the plurality of measurements, wherein receiving the cell switch command is in response to transmitting the one or more reports.

18. The UE of claim 12, wherein the cell switch command indicates a first transmission configuration indicator (TCI) state associated with the first candidate target cell, a second TCI state associated with the second candidate target cell, or both.

19. The UE of claim 12, wherein:
the cell switch command indicates one or more parameters associated with the first candidate target cell, associated with the second candidate target cell, or both, and
the one or more parameters indicate one or more timing advance values, one or more random access preambles, one or more synchronization signals, one or more random access masks, a quantity of repetitions, or any combination thereof.

20. The UE of claim 12, wherein each candidate target cell of the plurality of candidate target cells is associated with a respective transmit-receive point (TRP) of the virtual cell.

21. A network entity, comprising:
at least one processor; and
at least one memory coupled with the at least one processor, with instructions stored in the at least one memory, the instructions being executable by the at least one processor, individually or in any combination, to cause the network entity to:
output one or more control messages indicating at least one configuration of a plurality of configurations for a plurality of candidate target cells; and
output one or more cell switch commands, the one or more cell switch commands indicating a first candidate target cell of the plurality of candidate target cells for use in downlink communications, a second candidate target cell of the plurality of candidate target cells for use in uplink communications, or both.

22. The network entity of claim 21, wherein, to output the one or more cell switch commands, the instructions are executable by the at least one processor, individually or in any combination, to cause the network entity to:
output a first cell switch command indicating to switch to the first candidate target cell for downlink communications; or
output a second cell switch command indicating to switch to the second candidate target cell for uplink communications; or both.

23. The network entity of claim 22, wherein the first cell switch command, the second cell switch command, or both, comprises a respective identifier indicating a respective candidate target cell, a first bit indicating whether to switch to the respective candidate target cell for downlink communications, and a second bit indicating whether to switch to the respective candidate target cell for uplink communications.

24. The network entity of claim 22, wherein the first cell switch command, the second cell switch command, or both, comprises one or more fields operable to indicate either one or more downlink parameters or one or more uplink parameters.

25. The network entity of claim 21, wherein, to output the one or more cell switch commands, the instructions are executable by the at least one processor, individually or in any combination, to cause the network entity to:
output a first cell switch command indicating the first candidate target cell, the second candidate target cell, or both.

26. The network entity of claim 21, wherein the instructions are further executable by the at least one processor, individually or in any combination, to cause the network entity to:
switch a first user equipment (UE) from a first serving cell to the first candidate target cell for downlink communications, from the first serving cell to the second candidate target cell for uplink communications, or both, in response to outputting the one or more cell switch commands.

27. A network entity, comprising:
at least one processor; and
at least one memory coupled with the at least one processor, with instructions stored in the at least one memory, the instructions being executable by the at least one processor, individually or in any combination, to cause the network entity to:
output a control message indicating a configuration for a plurality of candidate target cells corresponding to a virtual cell comprising the plurality of candidate target cells; and
output a cell switch command, the cell switch command indicating a first candidate target cell of the plurality of candidate target cells for use in downlink communications, a second candidate target cell of the plurality of candidate target cells for use in uplink communications, or both.

28. The network entity of claim 27, wherein, to output the cell switch command, the instructions are executable by the at least one processor, individually or in any combination, to cause the network entity to:
output a first cell switch command comprising a first identifier indicating the first candidate target cell, a second identifier indicating the second candidate target cell, or both.

29. The network entity of claim 27, wherein:
the configuration comprises a single transmission configuration indicator (TCI) state pool associated with the plurality of candidate target cells, or
the configuration comprises a plurality of transmission configuration indicator (TCI) state pools each associated with a respective candidate target cell of the plurality of candidate target cells, wherein the cell switch command comprises one or more identifiers indicating one or more candidate target cells and one or more respective TCI state pools.

30. The network entity of claim 27, wherein the instructions are further executable by the at least one processor, individually or in any combination, to cause the network entity to:
switch a first user equipment (UE) from a first serving cell to the first candidate target cell for downlink communications, from the first serving cell to the second candidate target cell for uplink communications, or both, in response to outputting the cell switch command.
